(19) United States
(12) Patent Application Publication
(10) Pub. No.: US 2007/0272852 A1
(43) Pub. Date: Nov. 29, 2007

(54) Differential mobility spectrometer analyzer and pre-filter apparatus, methods, and systems

(75) Inventors: Raanan A. Miller, Chestnut Hill, MA (US); Erkinjon G. Nazarov, Lexington, MA (US); Anthony D. Bashall, Concord, MA (US)

Correspondence Address: ROPES & GRAY LLP;PATENT DOCKETING 39/41, ONE INTERNATIONAL PLACE, BOSTON, MA, 02110-2624, US

(73) Assignee: SIONEX CORPORATION, Bedford, MA (US)

(21) Appl. No.: 11/698,592

(22) Filed: Jan. 25, 2007

Related U.S. Application Data
(60) Provisional application No. 60/762,383, filed on Jan. 26, 2006.
(60) Provisional application No. 60/772,178, filed on Feb. 9, 2006.

(51) Int. Cl. B01D 59/44

(52) U.S. Cl. 250/288; 250/281; 250/290

(57) ABSTRACT

A sample analyzer including a MALDI ionization source, an ion mobility based filter for receiving ions from the MALDI ionization source and for providing a time-varying electric field through which select ions are passed, and a mass spectrometer for measuring the ion intensity of ions received from the ion mobility based filter.

### REFERENCE TO RELATED APPLICATIONS

This application claims priority to and the benefit of: U.S. Provisional Application No. 60/762,383, filed on Jan. 26, 2006, entitled “Differential Mobility Spectrometer Pre-filter Apparatus, Methods, and Systems” and U.S. Provisional Application No. 60/772,178, filed on Feb. 9, 2006, entitled “Ion Mobility Based Analysis of Molds and Related Volatile Organic Compounds”. The entire contents of the above-referenced applications are incorporated herein by reference.

This application also incorporates by reference the entire contents of the following co-pending U.S. patent applications: U.S. Ser. No. 10/824,674, filed on 14 Apr. 2004; U.S. Ser. No. 10/887,016, filed on 8 Jul. 2004; U.S. Ser. No. 10/894,861, filed on 19 Jul. 2004; U.S. Ser. No. 10/903,497, filed on 30 Jul. 2004; U.S. Ser. No. 10/916,249, filed on 10 Aug. 2004; U.S. Ser. No. 10/932, 986, filed on 2 Sep. 2004; U.S. Ser. No. 10/943,523, filed on 17 Sep. 2004; U.S. Ser. No. 10/981,001, filed on 4 Nov. 2004; U.S. Ser. No. 10/998,344, filed 24 Nov. 2004; U.S. Ser. No. 11/015,413, filed on 17 Dec., 2004; U.S. Ser. No. 11/035,800, filed on 13 Jan., 2005; U.S. Ser. No. 11/050,288, filed on 2 Feb. 2005; U.S. Ser. No. 11/070,904, filed on 3 Mar. 2005; U.S. Ser. No. 11/119,048, filed on 28 Apr. 2005; U.S. Ser. No. 11/293,651, filed on 3 Dec. 2005; U.S. Ser. No. 11/305,085, filed on 16 Dec. 2005; U.S. Ser. No. 11/331,333, filed on 11 Jan. 2006; U.S. Ser. No. 11/415,564, filed on 1 May 2006; U.S. Ser. No. 11/494,053, filed on 26 Jul. 2006; and U.S. Ser. No. 11/594,505, filed on 7 Nov. 2006

### FIELD OF THE INVENTION

This invention includes methods, systems, and apparatus of employing a differential mobility spectrometer (DMS) having improved sensitivity or to improve the sensitivity of mass spectrometry analysis. More particularly, a mobility based pre-filter, e.g., a DMS, may be employed to enhance the sensitivity of an Atmospheric Pressure (AP) Matrix Assisted Laser Desorption/Ionization (MALDI) source operating with a mass spectrometer (MS).

### BACKGROUND

Ion sources such as electrospray ionization (ESI) and MALDI have enabled more accurate molecular weight determinations of pure and/or uncontaminated samples using mass spectrometers. MALDI analysis has proven particularly useful in identifying biological and/or biochemical matter such as proteins in complex mixtures, analyzing laser capture microdissection samples, and characterizing protein complexes and micro-organisms. Because certain samples are often so complex, the detected mass spectrum may be ambiguous due to spectra overlap from multiple sample constituents. To reduce this problem, combination mass spectrometer systems have been employed such as liquid chromatography (LC)/MS, gas chromatography (GC)/MS, gel-electrophoresis/MS, and MS/MS to enable pre-separation of sample constituents before MS detection. Furthermore, an ion mobility spectrometer (IMS) may be combined with a MS to resolve and/or identify the constituents in complex biochemical samples. IMS/MS systems have been used to analyze biochemical matter such as peptide mixtures, intact bacteria (biomarker identification), peptide-peptide interactions, peptide-organic molecule interactions, and small molecules of contraband drugs. MALDI and ESI have been employed with the above combinations. Additionally, an orthogonal time-of-flight MS has been employed in combination with MALDI and IMS, e.g., a MALDI/IMS/OTOF MS system.

Traditionally, MALDI has been a vacuum ionization technique with a relatively high tolerance to sample contamination. Recently, AP-MALDI ion sources where the ions are produced at normal atmospheric pressure, have been employed. AP-MALDI reduces the complexity of introducing a sample into the high vacuum of a MS, improves ion yield due to fast thermal stabilization at atmospheric pressure, improves ability of coupling with other separation systems such a LC or capillary electrophoresis (CE), and reduces analyte fragmentation. As a disadvantage, AP-MALDI introduces ion losses and clustering between matrix and analyte ions, resulting in reduced analysis sensitivity and accuracy. Such clustering may be the result of processes such as thermalization of vibrationally excited ions along with ion-to-ion and ion-to-molecule reactions that may occur over a period of time. Because cluster ions are often more prevalent in heavier analytes such as proteins, certain analyzers employing AP-MALDI have be limited to detection of lighter analytes to maintain adequate sensitivity and accuracy measurements. Analyte clustering may also be dependent on the chemical nature of particular analytes which may also impact AP-MALDI sensitivity regardless of analyte weight. Accordingly, there is a need to reduce the adverse effects of AP-MALDI.

Another problem with a DMS analyzer is that one or more detector electrodes may be exposed to interference from other electronic components, especially with a component analyzer device. Accordingly, there is a need to minimize the effects of electric fields from other electronic components on the DMS detector electrodes.

A related problem associated more generally with the detection of volatile organic compounds is that existing analyzers are unable to provide rapid, accurate, and in-situ analysis and detection of such compounds.

### SUMMARY

The invention, in various embodiments, addresses deficiencies in the prior art by employing DMS filtering, along with other novel techniques, in combination with AP-MALDI to pre-filter contaminants, clusters, and other constituents before introduction into a MS and/or other detection system.

In one aspect, a tandem DMS/MS is employed with an PP-MALDI ionization source. The DMS provides pre-filtering of ions extracted from a MALDI plate to improve analysis sensitivity. In one configuration, the DMS is positioned axially in relation to the MS which allows neutrals that exit the DMS to enter the MS. In one embodiment, the DMS receives ions from a MALDI capillary. In another embodiment, the DMS also functions as the MALDI capillary.

In another configuration, the DMS is positioned perpendicularly to the MALDI capillary inlet and MS inlet. The perpendicular arrangement of the DMS improves the AP-MALDI/DMS/MS system sensitivity by allowing particular ions to be deflected into the DMS and/or MS during sample analysis while excluding other sample ions and/or contaminants. In yet another configuration, a pump provides transport and/or carrier gas flow within the DMS flow path to remove unwanted neutral and/or other constituents. The flow may be adjusted to optimize the separation and/or filtering out of neutrals, unwanted ions, and other contaminants before introduction of the selected ions into the MS. One or more deflector electrodes may defect and/or attract select ions from the DMS flow path into the perpendicularly positioned MS.

In another feature, pulsed dynamic focusing (PDF) is employed with AP-MALDI and the foregoing configurations in an AP-MALDI/DMS/MS system to further improve sample analysis sensitivity and reliability. By pulsing the laser output applied to a sample and varying the polarity and magnitude of the MALDI plate voltage before introduction into a DMS pre-filter, the sensitivity of an AP-MALDI/DMS/MS system is significantly enhanced. In one feature, the MALDI plate voltage and polarity are maintained constant for a period of time after the laser pulse period to enhance ionization.

In another feature, the invention employs a novel capillary to collect sample ions from a desorption surface, e.g., MALDI plate. In one configuration, the capillary inlet is surrounded by a gas outlet that propels hot clean gas substantially onto the ion desorption surface. The inner capillary receives the ions from the desorption surface while the hot clean gas produces a shroud and/or gas barrier that reduces the introduction of contaminants into the capillary. In another feature, the inner capillary includes a substantially bi-conical outer surface shape substantially near the capillary outlet and/or a like configuration to direct the flow of hot clean gas radially away from the sample ion source on the desorption surface.

In another feature, the invention includes a compact portable ion mobility based analyzer. The analyzer includes a sample introduction section for collecting an airborne sample where the sample may possibly include at least one volatile organic compound. The analyzer also includes an ion source for ionizing a portion of the sample, an ion mobility based filter for filtering out the at least one volatile organic compound, a detector for acquiring detection data associated with the at least one volatile organic compound, and a processor for identifying the at least one volatile organic compound by comparing the acquired detection data with a data store including a plurality of detection data sets. Each detection data set may be associated with a known volatile organic compound.

In a further aspect, the invention includes an ion mobility based analyzer having an ion mobility based filter for passing through select ions, a detector for detecting ions from the ion mobility based filter, an insulating substrate in communication with the detector, and a shield in communication with the insulating substrate for reducing the amount of electrostatic interference to the detector.

The insulating substrate may include at least one of glass, silicon, a polymer, and a semi-conductive material. The detector may include at least one electrode that is micromachined to the insulating substrate. In one configuration, the insulating substrate is positioned substantial between the detector and the shield. The substrate supporting the detector electrode may be insulating or partially conductive and may be partially contacting the sheild. The sheild may be a faraday cage like structure. The sheild may be a three dimensional structure. The shield may be embedded on a top surface of the insulating surface while at least one electrode of the detector is embedded on a substantially opposing bottom surface of the insulating surface. The shield may include a conductive material that is maintained at a select electrical potential.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a conceptual diagram of an AP-MALDI/MS system according to the present invention.

FIG. 2 is a conceptual diagram of an AP-MALDI/DMS/MS system according to an illustrative embodiment of the invention.

FIG. 3 is a conceptual diagram of another AP-MALDI/DMS/MS system according to an illustrative embodiment of the invention.

FIG. 4 is a conceptual diagram of yet another AP-MALDI/DMS/MS system according to an illustrative embodiment of the invention.

FIG. 5 is a conceptual diagram of a DMS that is used as a pre-filter for an mass spectrometer according to an illustrative embodiment of the invention.

FIG. 6 is a conceptual diagram of an AP-MALDI/MS system employing a mobility based filter such as a DMS, IMS, and/or combination DMS/IMS filter according to an illustrative embodiment of the invention.

FIG. 7A is a graph of laser beam light intensity (or laser voltage) versus time according to an illustrative embodiment of the invention.

FIG. 7B is a graph of MALDI plate voltage versus time according to an illustrative embodiment of the invention.

FIG. 8 is a conceptual diagram of an AP-MALDI/MS system employing a mobility based filter such as a DMS, IMS, and/or combination DMS/IMS filter according to an illustrative embodiment of the invention.

FIG. 9A is a graph of laser beam light intensity (or laser voltage) versus time according to an illustrative embodiment of the invention.

FIG. 9B is a graph of MALDI plate voltage versus time according to an illustrative embodiment of the invention.

FIG. 10A is a graph of voltage (response) versus time as detected by a MS for LipidA according to an illustrative embodiment of the invention.

FIG. 10B is a graph of voltage (response) versus time as detected by a MS for Glu-Val-Phe according to an illustrative embodiment of the invention.

FIG. 10C is a graph of voltage (response) versus time as detected by a MS for DHB+TFA (matrix) according to an illustrative embodiment of the invention.

FIG. 11A is a conceptual diagram of an AP-MALDI source without PDF according to an illustrative embodiment of the invention.

FIG. 11B is a conceptual diagram of an AP-MALDI source employing PDF according to an illustrative embodiment of the invention.

FIG. 12 is a conceptual diagram of a capillary tube for receiving ions from a desorption surface that includes an outer tube for the delivery of a gas shroud around the sample collection area of the desorption surface according to an illustrative embodiment of the invention.

FIG. 13 is a conceptual diagram of a inner capillary tube of an AP-MALDI source for receiving ions from a desorption surface that includes an outer tube for the delivery of a gas shroud around the sample collection area of the desorption surface according to an illustrative embodiment of the invention.

FIG. 14 is a diagram of the ion flow from a desorption plate where a potential of 0 volts is applied to the capillary tube and desorption surface, resulting in no electric field according to an illustrative embodiment of the invention.

FIG. 15 is a diagram of the ion flow from a desorption plate where a potential of 1000 volts is applied to the capillary tube and desorption surface, resulting in an electric field and ion flow into the capillary tube according to an illustrative embodiment of the invention.

FIG. 16 is a diagram of the ion flow from a desorption plate where a potential is applied to the capillary tube and desorption surface, resulting in an electric field and ion flow into the capillary tube according to an illustrative embodiment of the invention.

FIG. 17 is a conceptual diagram of a compact ESI/DMS/MS system according to an illustrative embodiment of the invention.

FIG. 18 is a block diagram of a GC-DMS system according to an illustrative embodiment of the invention.

FIG. 19A is a more detailed conceptual diagram of a GC-DMS according to an illustrative embodiment of the invention.

FIG. 19B is a conceptual diagram of a compact GC-DMS having an ionization source located between the GC and the field electrodes of the DMS according to an illustrative embodiment of the invention.

FIG. 19C is a conceptual diagram of a compact GC-DMS which avoids exposing the GC sample directly to an ionization source, by locating the ionization source prior to the outlet of the GC column so that the DMS drift gas or constituents of the drift gas, e.g., dopants, are ionized and then mix and interact with the sample molecules

FIG. 20 is a conceptual diagram of an ion mobility based analyzer including detector shielding plates according to an illustrative embodiment of the invention.

FIG. 21 is a perspective view of an insulating substrate associated with an ion mobility based analyzer including a shielding plate according to an illustrative embodiment of the invention.

FIG. 22 is a perspective view of another insulating substrate associated with an ion mobility based analyzer including a shielding section for shielding a detector according to an illustrative embodiment of the invention.

FIG. 23 is a another perspective view of an insulating substrate associated with an ion mobility based analyzer including a shielding section for shielding a detector according to an illustrative embodiment of the invention.

FIG. 24 is a graph of ion intensity vs. compensation voltage (i.e., noise amplitude) of an unshielded ion mobility based detector during a horizontal shake test.

FIG. 25 is a graph of ion intensity vs. compensation voltage (i.e., noise amplitude) of a shielded ion mobility based detector during a horizontal shake test.

FIG. 26 is a block diagram of a GC-DMS sensor system including a wireless interface according to an illustrative embodiment of the invention.

### DETAILED DESCRIPTION

The invention addresses certain deficiencies of the prior art by providing, in various embodiments, improved sensitivity and accuracy of analysis for AP-MALDI/MS systems using a differential mobility spectrometers (DMS) to pre-filter sample constituents before MS detection.

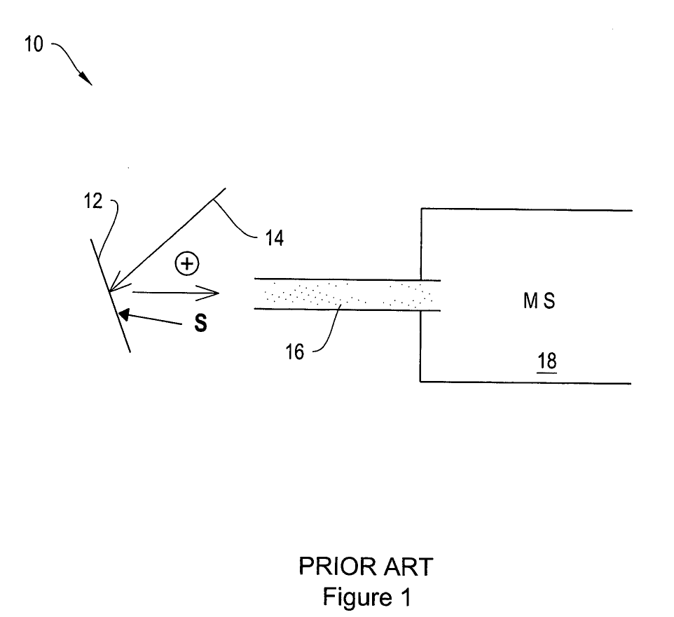

FIG. 1 is a conceptual diagram of an AP-MALDI/MS system 10 including a MALDI plate and/or desorption surface 12, a laser beam 14, capillary 16 and MS 18. In operation, a sample S is placed on the desorption surface 12. Initially the sample S may be suspended in liquid or be in a liquid form. The sample S is allowed to dry over a period of, for example, thirty minutes. Once dry, a laser source emits the laser beam 14 which contacts the sample S on the desorption surface 12, resulting in the emission of ions. The ions enter and/or are drawn into the capillary 16 and delivered to the MS 18 for detection. The AP-MALDI/MS system 10, due in part to exposure to atmospheric pressure, may experience ion losses and clustering of the sample ions, resulting in reduced analysis sensitivity and accuracy. Such clustering may be the result of processes such as thermalization of vibrationally excited ions along with ion-to-ion and ion-to-molecule reactions that may occur over a period of time. Because cluster ions are often more prevalent in heavier analytes such as proteins, the AP-MALDI/MS system 10 may be limited to detecting lighter analytes to maintain adequate sensitivity and accuracy measurements. Analyte clustering may also be dependent on the chemical nature of particular analytes which may also impact the AP-MALDI/MS system 10 sensitivity regardless of analyte weight.

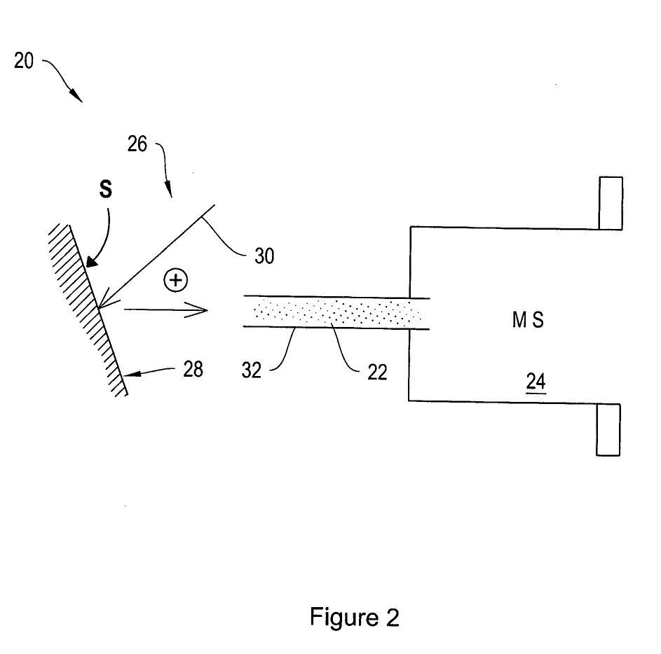

FIG. 2 is a conceptual diagram of an AP-MALDI/DMS/MS system 20 according to an illustrative embodiment of the invention. The AP-MALDI/DMS/MS system 20 includes a DMS 22, a MS 24, and an AP-MALDI ion source 26. The AP-MALDI ion source 26 includes a MALDI plate/desorption surface 28, a laser beam 30, and a capillary 32. In certain embodiments, the housing, or at least a portion thereof, of DMS 22 is also the capillary 32. The proximity of the capillary 32 to the desorption surface 28 may be about 1-4 mm. The diameter of the capillary 32 may be about 1-2 mm outer diameter and about 500-900 um inner diameter. The end of the capillary 32 may be sharpened at an angle of about 25-45 degrees. The MALDI plate 28 may be stainless steel and/or have a gold surface with a surface area of about 3 mm×5 mm, about 1.5 mm×2.5 mm, and about 1 mm×2 mm. The source of the laser beam 30 may be a pulsed and/or continuous nitrogen laser operating in the Infrared and/or Ultraviolet ranges. For example, the nitrogen laser may emit ultraviolet radiation at about 337.1 nm. Under certain circumstances, a positive, negative, and/or combination of positive and negative voltages may be applied to the MALDI plate of about 1-4 kvolts. In certain circumstances, the capillary 32 may be operated at temperatures of about 150-250 degrees centigrade.

In operation, a sample S is placed on the desorption surface 28. Initially the sample S may be suspended in liquid or be in a liquid form. The sample S is allowed to dry over a period of time. Once dry, a laser source emits the laser beam 30 which contacts the sample S on the desorption surface 28, resulting in the emission of ions. The ions enter and/or are drawn into the capillary 32 and delivered to the DMS 22. The DMS 22 is positioned axially in relation to the capillary 32 and MS 24. The DMS 22 provides pre-filtering of ions extracted from a MALDI plate to improve analysis sensitivity. In certain embodiments, RF field and compensation field of the DMS 22 are adjusted to selectively filter and/or pre-separate particular ion species of the sample S before introduction into the MS 24. In this instance, the filtered ion may be neutralized into neutrals to prevent their detection by the MS 24. While the DMS filter 22 advantageously pre-filters select ions before MS 24 detection, neutrals may subsequently interact with the remaining ions that exit the DMS 22. These interactions may reduce the sensitivity, accuracy, and stability of the AP-MALDI/DMS/MS system 20.

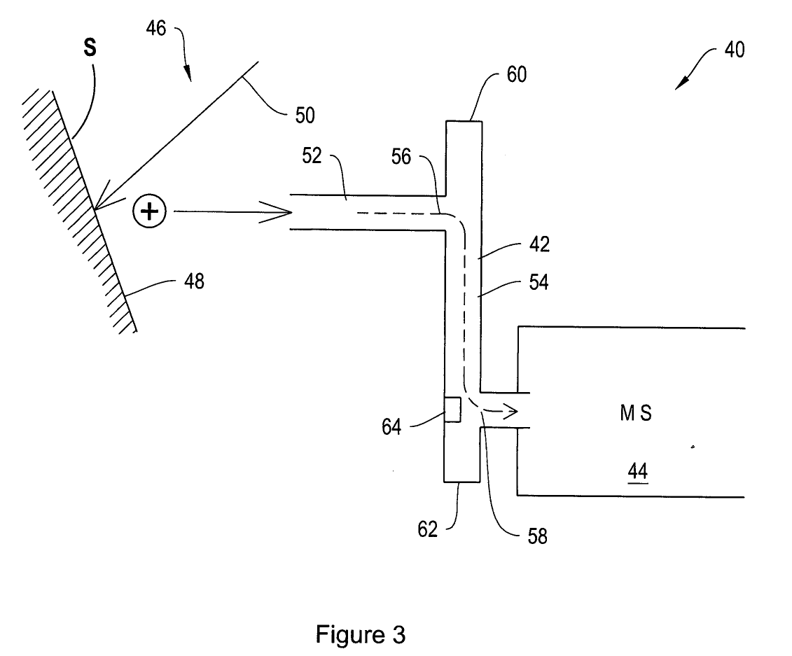

FIG. 3 is a conceptual diagram of an AP-MALDI/DMS/MS system 40 according to an illustrative embodiment of the invention. The AP-MALDI/DMS/MS system 40 includes a DMS 42, a MS 44, an AP-MALDI ion source 46, flow channel 54, flow channel inlet 56, and MS inlet 58, flow channel inlet/outlet 60, and flow channel inlet/outlet 62, and deflector 64. The AP-MALDI ion source 46 includes a MALDI plate/desorption surface 48, a laser beam 50, and a capillary 52. In the illustrative embodiment, the DMS 42 within the flow channel 54 is positioned substantially perpendicularly to the MALDI capillary 52 and the MS inlet 58. The perpendicular arrangement of the DMS 42 improves the AP-MALDI/DMS/MS system 40 sensitivity by, for example, allowing particular ions to be deflected into the DMS 42 and/or MS 44 during sample S analysis while excluding other sample ions and/or contaminants.

In operation, a sample S is placed on the desorption surface 48. Initially the sample S may be suspended in liquid or be in a liquid form. The sample S is allowed to dry over a period of time. Once dry, a laser source emits the laser beam 50 which contacts the sample S on the desorption surface 48, resulting in the emission of ions. The ions enter and/or are drawn into the capillary 52 and delivered to the flow channel 54 via the flow channel inlet 56. The flow channel 54 may contain a carrier and/or transport gas that flows toward flow channel inlet/outlet 60 or inlet/outlet 62. The DMS 42 may employ a longitudinal field to propel ions through the DMS 42 and toward the MS inlet 58. Otherwise, a transport gas may deliver filtered ions from the DMS 42 to the MS inlet 58.

In certain embodiments, the deflector 64 directs ions into the MS 44 via the MS inlet 58. The DMS 42 provides pre-filtering of ions extracted from a MALDI plate 48 to improve analysis sensitivity. In some embodiments, the RF field and compensation field of the DMS 42 are adjusted to selectively filter and/or pre-separate particular ion species of the sample S before introduction into the MS 44. In this instance, the filtered ion may be neutralized into neutrals and then either expelled via the inlet/outlets 60 and 62 or introduced as neutrals into the MS 44 via MS inlet 58. While the DMS filter 42 advantageously pre-filters select ions before MS 44 detection, neutrals may subsequently interact with the remaining ions that exit the DMS 42. To prevent and/or reduce such interactions, the neutrals may be expelled from the flow channel 54 via the inlet/outlets 60 and 62 while selected ions are directed into the MS 44 by the deflector 64.

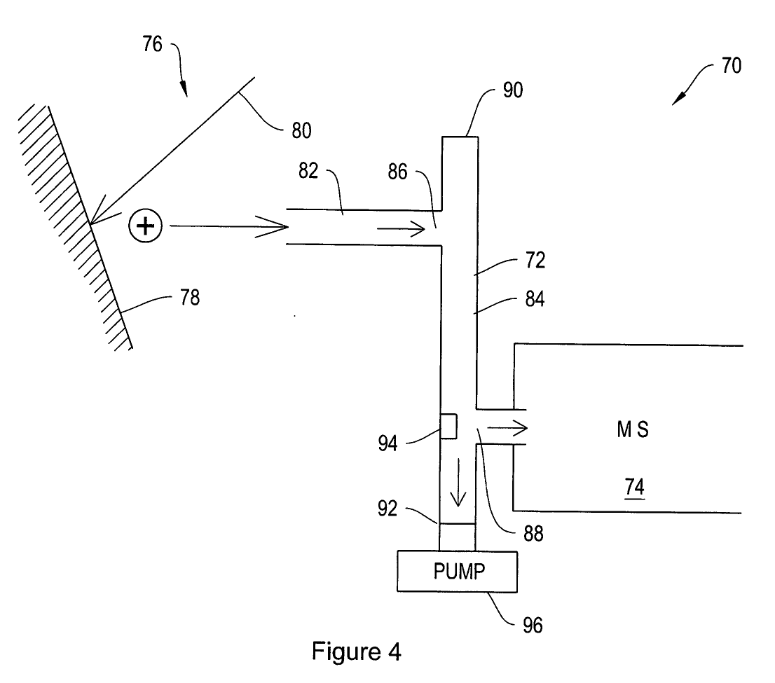

FIG. 4 is a conceptual diagram of an AP-MALDI/DMS/MS system 70 according to an illustrative embodiment of the invention. The AP-MALDI/DMS/MS system 70 includes a DMS 72, a MS 74, an AP-MALDI ion source 76, flow channel 84, flow channel inlet 86, and MS inlet 88, flow channel inlet/outlet 90, and flow channel inlet/outlet 92, deflector 94, and pump 96. The AP-MALDI ion source 76 includes a MALDI plate/desorption surface 78, a laser beam 80, and a capillary 82. In the illustrative embodiment, the DMS 72 within the flow channel 84 is positioned substantially perpendicularly to the MALDI capillary 82 and the MS inlet 88. The perpendicular arrangement of the DMS 72 improves the AP-MALDI/DMS/MS system 70 sensitivity by, for example, allowing particular ions to be deflected into the DMS 72 and/or MS 74 during sample S analysis while excluding other sample ions and/or contaminants.

In operation, a sample S is placed on the desorption surface 78. Initially the sample S may be suspended in liquid or be in a liquid form. The sample S is allowed to dry over a period of time. Once dry, a laser source emits the laser beam 80 which contacts the sample S on the desorption surface 78, resulting in the emission of ions. The ions enter and/or are drawn into the capillary 82 and delivered to the flow channel 84 via the flow channel inlet 86. The flow channel 84 may contain a carrier and/or transport gas that flows toward either flow channel inlet/outlet 90 or inlet/outlet 92. The DMS 72 may employ a longitudinal field to propel ions through the DMS 72 and toward the MS inlet 88. Otherwise, a transport gas may deliver filtered ions from the DMS 72 to the MS inlet 88. A pump 96 may adjustably control the flow rate within the flow channel 84 to optimize the separation of selected ions from neutrals and/or other contaminants.

In certain embodiments, the deflector 94 directs ions into the MS 74 via the MS inlet 88. The DMS 72 provides pre-filtering of ions extracted from a MALDI plate 78 to improve analysis sensitivity. In some embodiments, the RF field and compensation field of the DMS 72 are adjusted to selectively filter and/or pre-separate particular ion species of the sample S before introduction into the MS 74. In this illustrative instance, the filtered ion are neutralized into neutrals and then either expelled via the inlet/outlets 90 and 92 depending on the flow direction and/or flow rate set by the pump 96. While the DMS filter 72 advantageously pre-filters select ions before MS 74 detection, neutrals may subsequently interact with the remaining ions that exit the DMS 72. To prevent and/or reduce such interactions, the neutrals may be expelled from the flow channel 84 via the inlet/outlets 90 and 92 while selected ions are directed into the MS 74 by the deflector 94.

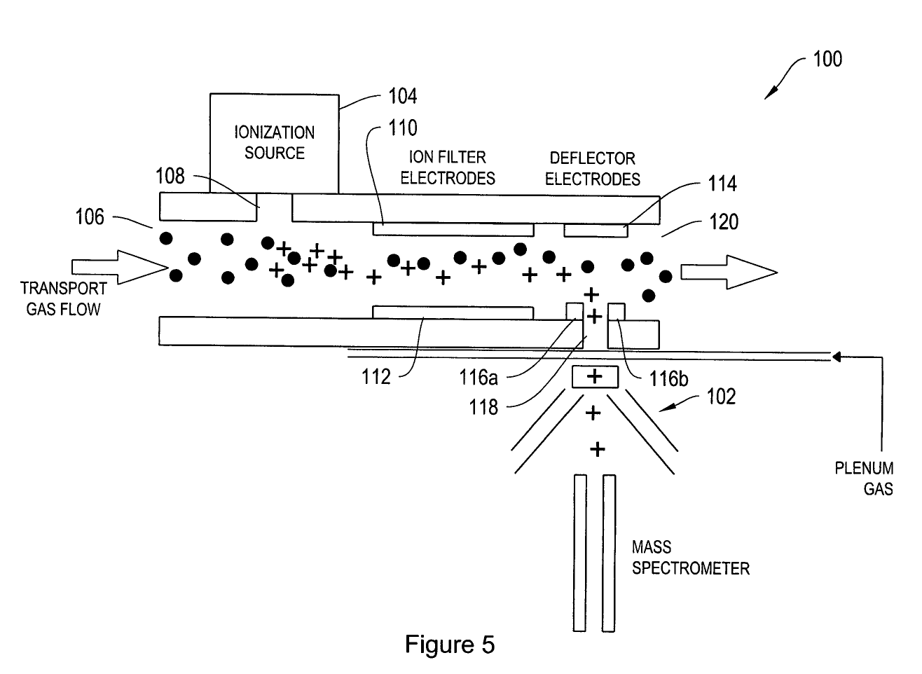

FIG. 5 is a conceptual diagram of a DMS 100 that is used as a pre-filter for an MS 102. The ionization source 104 may be a MALDI ion source, an AP-MALDI ion source, an ESI source, and like sources. The DMS 100 includes a gas inlet 106, ionization source inlet 108, DMS filter electrodes 110 and 112, deflector electrodes 104, 116a, and 116b, MS inlet orifice 118, and outlet 120. A plenum gas may be employed at the interface between the DMS 100 and MS 102.

In operation, the DMS 100 functions in a similar manner as the DMS 72 of FIG. 4. Of particular interest is the use of the deflectors 114, 116a, and 116b which direct selected ions through the orifice 118 into the MS 102 for mass spectrometer detection. In one embodiment electrodes 116a and 116b are one electrode 116 with the orifice 118 being embedded in the electrode 116. In another embodiment, the electrodes 116a and 116b are separate electrodes adjacent to the orifice 118. In certain embodiments, the electrode 114 is biased to deflect and/or repel ions toward the orifice 118 while the electrode 116 is biased to attract selected ions toward the orifice 118. For example, to direct positive ions through the orifice 118 to the MS 102, a relatively negative voltage is applied to the deflector 114 while a relatively positive voltage is applied to the electrode 116. As in previously described illustrative embodiments, the deflector electrodes 114 and 116 direct select ions to the MS 102 for detection while neutrals (at least a portion of which are neutralized by the DMS filter electrodes 110 and 112) are expelled through the outlet 120. Such a DMS 100 pre-filter configuration and process advantageously decreases the effects of ion-molecule processes in the interface area of, for example, an AP-MALDI/MS by substantially eliminating the presence of neutrals.

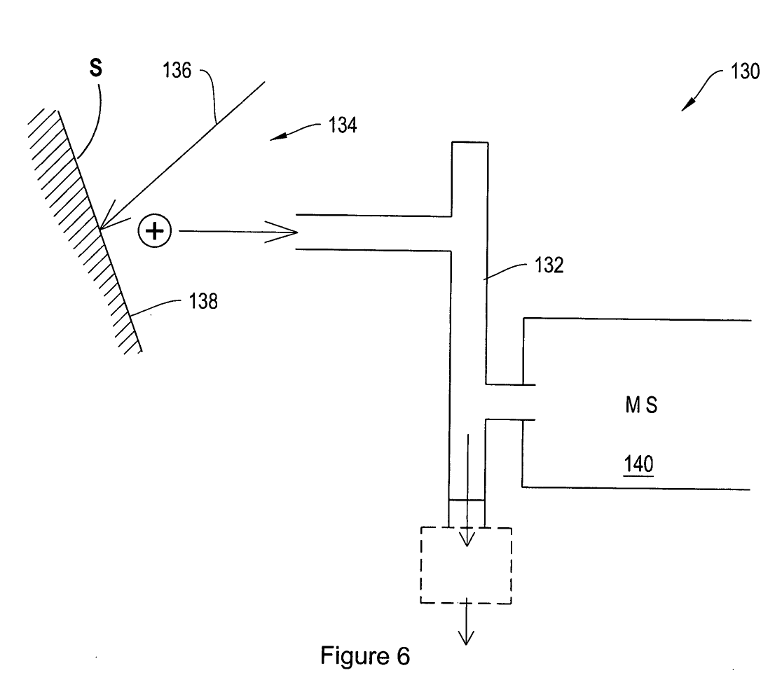

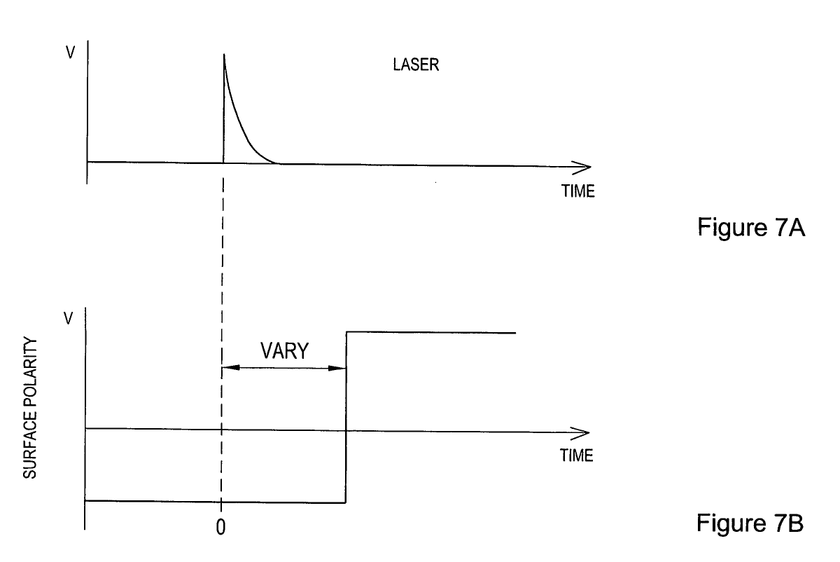

FIG. 6 is a conceptual diagram of an AP-MALDI/MS system 130 employing a mobility based filter 132 such as a DMS, IMS, and/or combination DMS/IMS filter according to an illustrative embodiment of the invention. The system 130 functions in a similar manner as the previously described illustrative embodiments. In on embodiment, the AP-MALDI source 134 employs pulsed dynamic focusing (PDF) to further improve sample analysis sensitivity and reliability. By pulsing the laser beam 136 (See FIG. 7A) applied to a sample S and varying the polarity and magnitude of the MALDI plate 138 voltage (See FIG. 7B) before introduction into the mobility-base filter 132, the sensitivity of the system 130 is significantly enhanced.

FIG. 7A is a graph of laser beam light intensity (or laser voltage) versus time according to an illustrative embodiment of the invention. FIG. 7B is a graph of MALDI plate voltage versus time according to an illustrative embodiment of the invention. As shown in FIG. 7B, the variation in voltage and/or polarity of the MALDI plate 138 may be adjusted with respect to time and the laser beam 136 pulse (FIG. 7A) to optimize ion creation and/or collection by the AP-MALDI source 134.

The mobility based filter 132 may include a DMS, IMS, and/or combination of DMS and IMS filters in series and/or parallel to enable filtering of select ion species before introduction into the MS 140. Such combinations are described in further detail in U.S. patent application Ser. No. 11/119,048, filed Apr. 28, 2005, entitled “Systems and Methods for Ion Species Analysis with Enhanced Condition Control and Data Interpretation,” the entire contents of which are incorporated herein by reference.

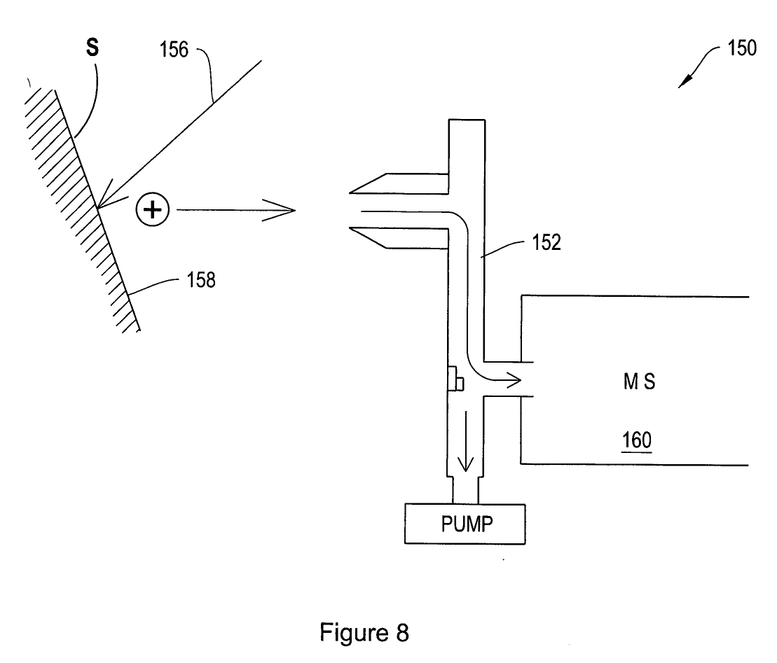

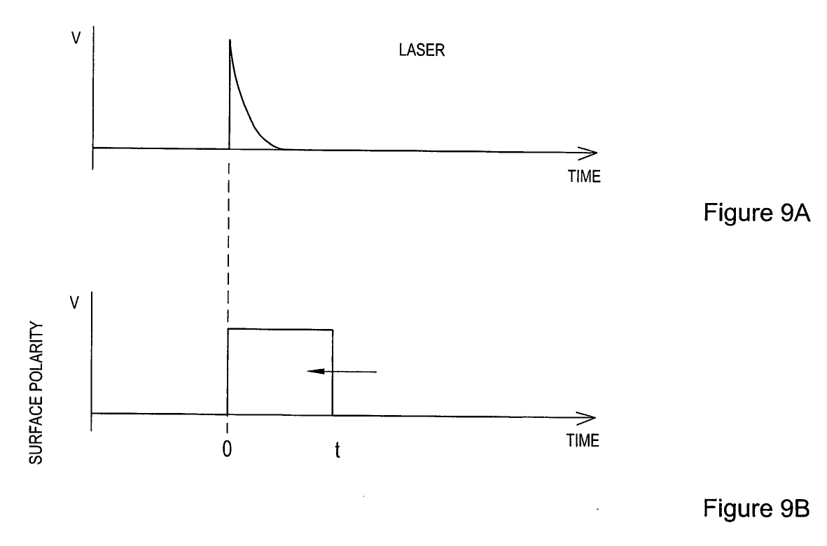

FIG. 8 is a conceptual diagram of an AP-MALDI/MS system 150 employing a mobility based filter 152 such as a DMS, IMS, and/or combination DMS/IMS filter according to an illustrative embodiment of the invention. The system 150 functions in a similar manner as the previously described illustrative embodiments. In on embodiment, the AP-MALDI source 154 employs pulsed dynamic focusing (PDF) to further improve sample analysis sensitivity and reliability. By pulsing the laser beam 156 (See FIG. 9A) applied to a sample S and maintaining the polarity and magnitude of the MALDI plate 138 voltage (See FIG. 9B) constant for a period of time t in relation to the laser beam 156 pulse, ion creation and collection from a sample S may be optimized. For example the MALDI plate 158 voltage may be set to 2-4 Kv for an adjustable period of time t before ion introduction into the mobility-base filter 152, enabling the sensitivity of the system 150 to be significantly enhanced.

FIG. 9A is a graph of laser beam light intensity (or laser voltage) versus time according to an illustrative embodiment of the invention. FIG. 9B is a graph of MALDI plate voltage versus time according to an illustrative embodiment of the invention. As shown in FIG. 9B, the voltage of the MALDI plate 158 may be adjusted and/or set to a specific level with respect to time and the laser beam 136 pulse (FIG. 9A) to optimize ion creation and/or collection by the AP-MALDI source 154.

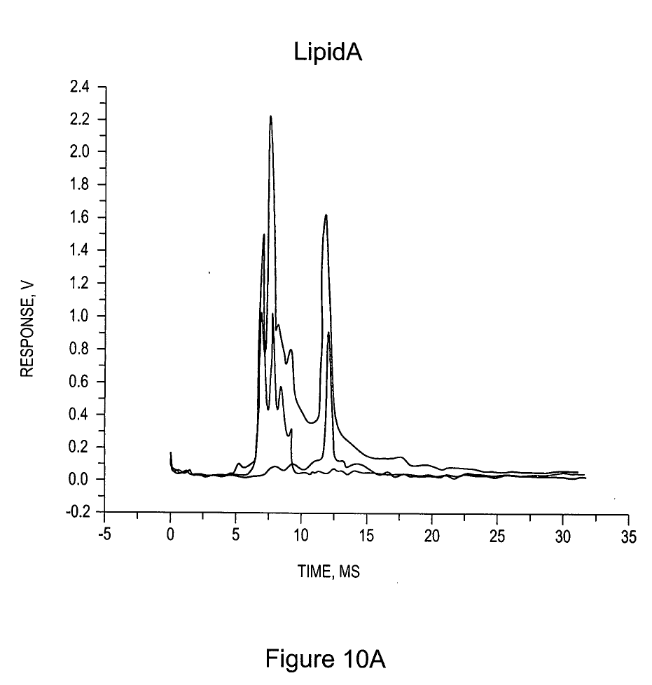

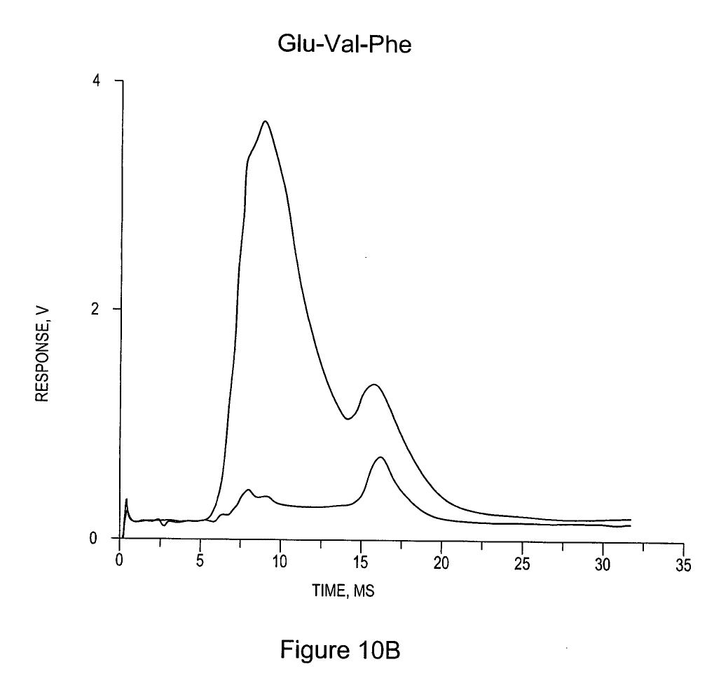

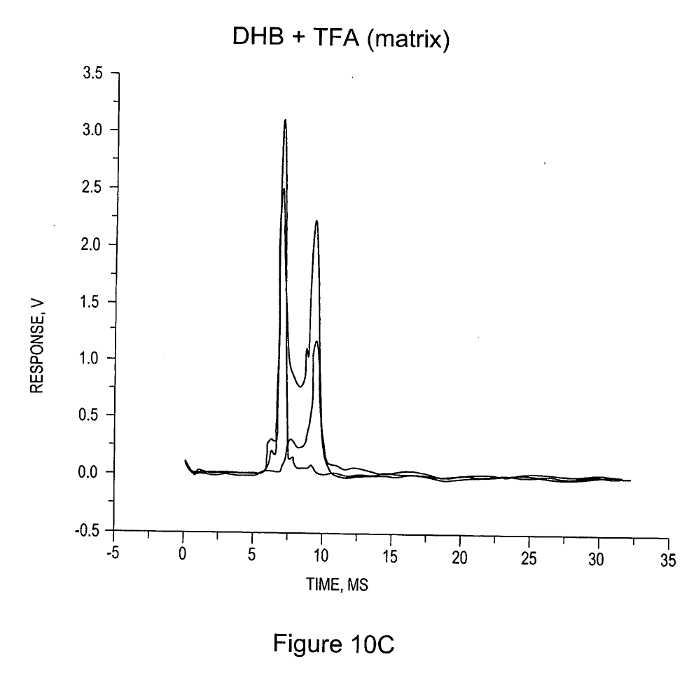

FIG. 10A is a graph of voltage (response) versus time as detected by the MS 160 of the system 150 for LipidA. FIG. 10B is a graph of voltage (response) versus time as detected by the MS 160 of the system 150 for Glu-Val-Phe. FIG. 10C is a graph of voltage (response) versus time as detected by the MS 160 of the system 150 for DHB+TFA (matrix). FIGS. 1A-10C illustrate the improved spectra provided by pulsed dynamic focusing on the inlet of a mobility-based filter such as a DMS.

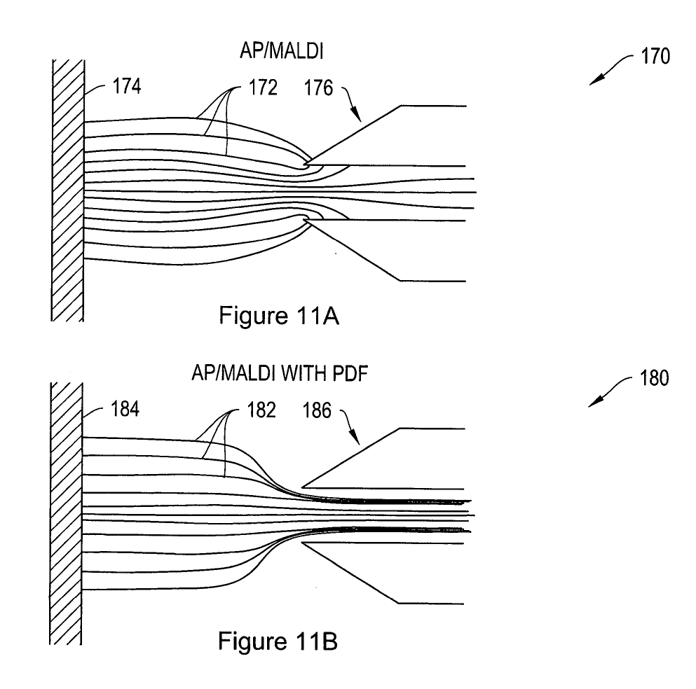

FIG. 11A is a conceptual diagram of an AP-MALDI source 170 without PDF. As shown, the ion paths 172 from the MALDI plate 174 to the capillary 176 are such that a portion of the ions are not drawn into the capillary 176, resulting in reduced stability, accuracy, and sensitivity.

FIG. 11B is a conceptual diagram of an AP-MALDI source 180 employing PDF. As shown, the ion paths 182 from the MALDI plate 184 to the capillary 186 are focused by the PDF such that a substantial greater portion of the ions are not drawn into the capillary 186, resulting in enhanced stability, accuracy, and sensitivity.

In certain embodiments, the invention employs a novel capillary to collect sample ions from a desorption surface, e.g., a MALDI plate.

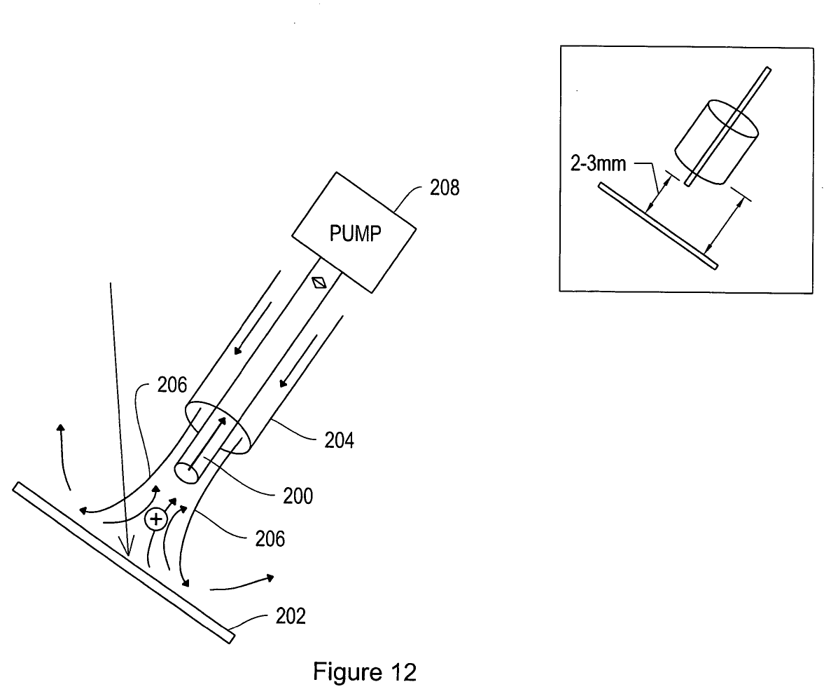

FIG. 12 is a conceptual diagram of a capillary tube 200 for receiving ions from a desorption surface 202 that includes an outer tube 204 for the delivery of a gas shroud 206 around the sample collection area of the desorption surface 202. The capillary tube 200 is surrounded by the gas outlet of the outer tube 204 that propels hot clean gas substantially onto the ion desorption surface 202. The inner capillary tube 200 receives the ions from the desorption surface 202 while a hot clean gas shroud reduces the introduction of contaminants into the capillary tube 200. The hot clean gas may flow at about 1-3 L/min while the ions may be desorbed from the surface 202 at about 0.5-1.5 L/min. The inner diameter of the capillary tube may be about 0.5 to 1 mm in diameter while the end of the capillary tube 200 may be about 0.5 to 3 mm from the desorption surface 202. In one embodiment, a pump 208 provides the gas flow and/or vacuum within the capillary tube 200 to draw ions into the capillary tube. The pump 208 and/or a like pump may provide the flow of hot gas from the out tube 204 to produce the gas shroud 206.

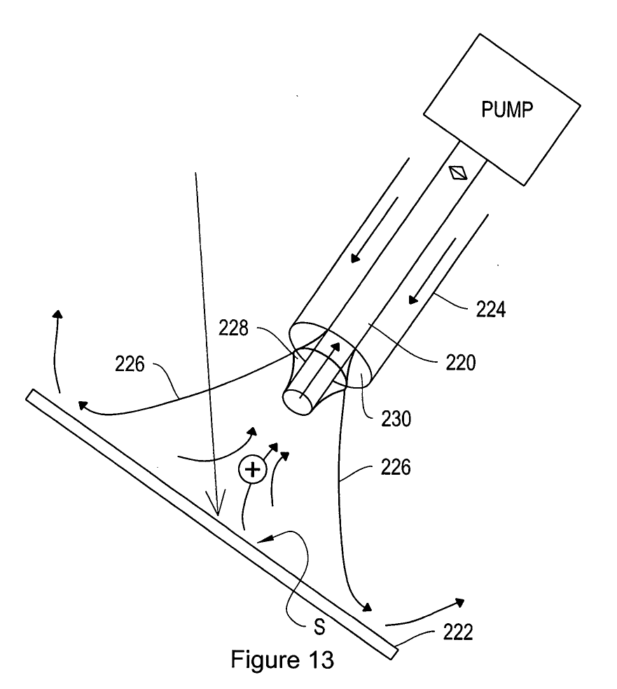

FIG. 13 is a conceptual diagram of a inner capillary tube 220 of an AP-MALDI source for receiving ions from a desorption surface 222 that includes an outer tube 224 for the delivery of a gas shroud 206 around the sample collection area of the desorption surface 202. The inner capillary tube 220 includes a substantially bi-conical outer surface structure 228 substantially near the outer tube 224 outlet 230, and/or a like configuration, to direct the flow of hot clean gas radially away from the sample S ion source on the desorption surface 222.

In certain embodiments, a voltage may be applied to the outer tube 224 and/or the inner capillary tube 220 to enhance ion transfer to the capillary tube 220. In some embodiments, the capillary tube 220, outer tube 224, and desorption surface may have each be set at a voltage potential to establish an electric field that enhances ion collection by the capillary tube 220.

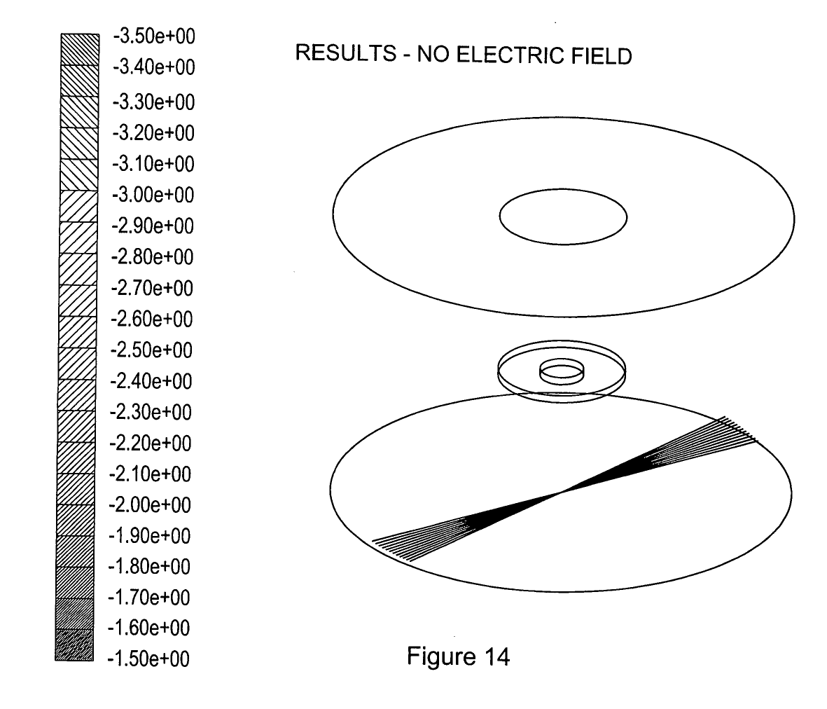

FIG. 14 is a diagram of the ion flow from a desorption plate where a potential of 0 volts is applied to the capillary tube and desorption surface, resulting in no electric field.

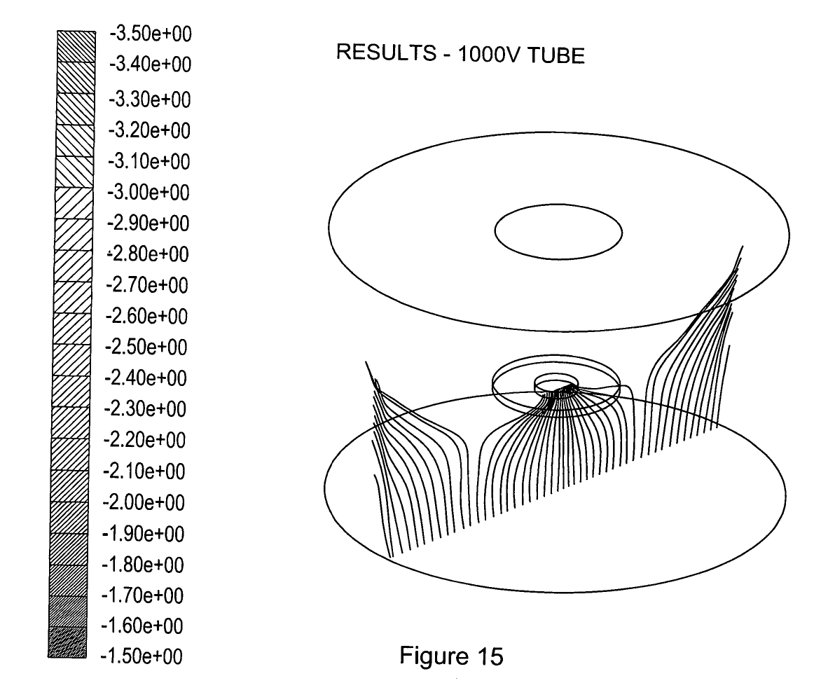

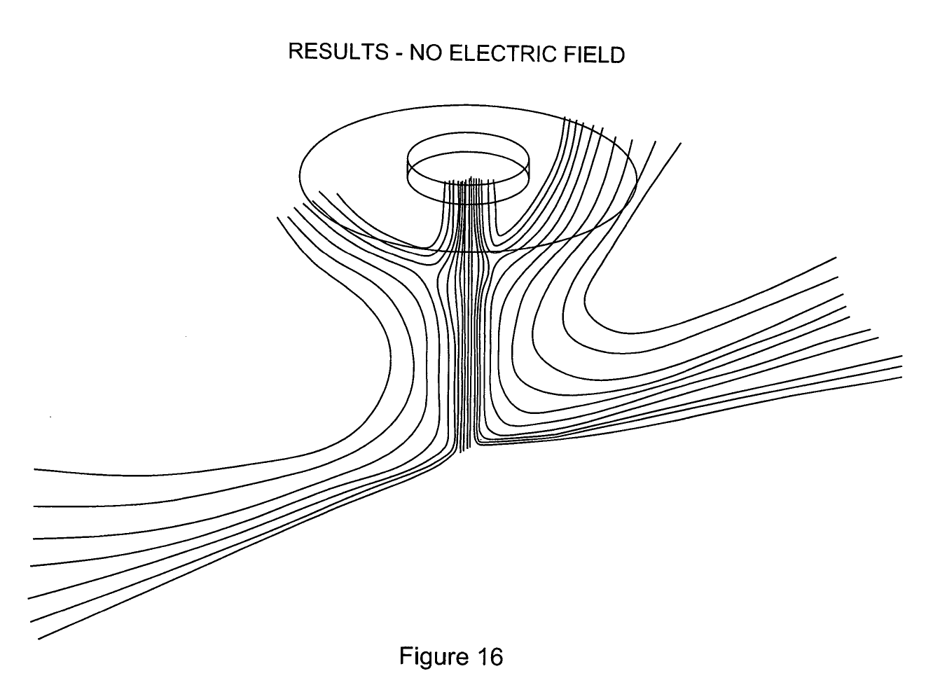

FIG. 15 is a diagram of the ion flow from a desorption plate where a potential of 1000 volts is applied to the capillary tube and desorption surface, resulting in an electric field and ion flow into the capillary tube.

FIG. 16 is a diagram of the ion flow from a desorption plate where a potential is applied to the capillary tube and desorption surface, resulting in an electric field and ion flow into the capillary tube. The diagram also illustrates that ions within about 1 mm of the inner capillary tube are drawn in while other ions are pushed away. Thus, in certain embodiments, the suction flow from the inner capillary is effective for about 1 inner capillary tube diameter. In another embodiment, applying about 1000v to the outer tube and the desorption/target wall results in substantially all ions being drawn into the inner capillary tube.

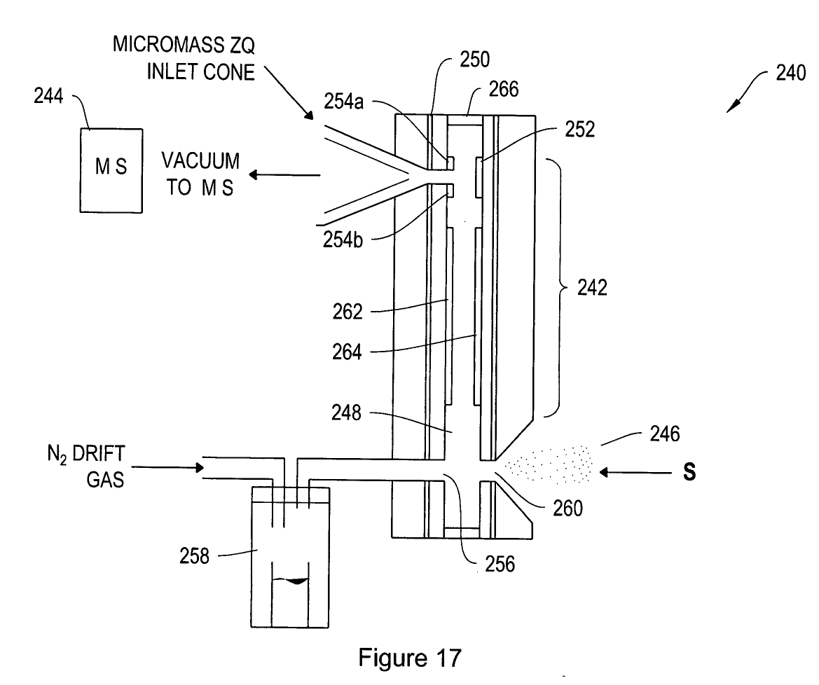

FIG. 17 is a conceptual diagram of a compact ESI/DMS/MS system 240 according to an illustrative embodiment of the invention. The ESI/DMS/MS system 240 includes a DMS 242, a MS 244, an ESI ion source 246, flow channel 248, MS inlet orifice 250, detector/deflector electrodes 252, 254a, and 254b. The system 240 may also include transport/carrier gas inlet 256, and dopant and/or gas mixing chamber 258.

In operation, a sample is ionized in the ESI source 246, e.g., a nanoESI. The ions enter and/or are drawn into the flow channel 248 via the ion inlet 260. The flow channel 248 may contain a carrier and/or transport gas including various mixtures of gas and/or dopants introduce via the inlet 256 from the mixing chamber 258. The DMS 242 may employ a longitudinal field to propel ions through the flow channel 248 and toward the MS inlet 250. Otherwise, a transport gas may deliver filtered ions from the DMS 242 to the MS inlet 250. A pump may be employed to adjustably control the flow rate within the flow channel 248 to optimize the separation of selected ions from neutrals and/or other contaminants. The deflector/detector electrodes 252, 254a, and 254b may detect and/or direct select ions from the DMS filter electrodes 262 and 264 toward the MS inlet 250.

In some embodiments, the RF field and compensation field of the DMS filter electrodes 262 and 264 are adjusted to selectively filter and/or pre-separate particular ion species of the sample S before introduction into the MS 244. In this illustrative instance, the filtered ion are neutralized into neutrals and expelled through an outlet other than the MS inlet 250. While the DMS filter 242 advantageously pre-filters select ions before MS 244 detection, neutrals may subsequently interact with the remaining ions that exit the DMS 242. To prevent and/or reduce such interactions, the neutrals may be expelled from the flow channel 248 from the outlet 266 while selected ions are directed into the MS 244 by the electrodes 252, 254a, and 254b.

In one embodiment electrodes 254a and 254b are one electrode 254 with the orifice 250 being embedded in the electrode 254. In another embodiment, the electrodes 254a and 254b are separate electrodes adjacent to the orifice 250. In certain embodiments, the electrode 252 is biased to deflect and/or repel ions toward the orifice 250 while the electrode 254 is biased to attract selected ions toward the orifice 250. For example, to direct positive ions through the orifice 250 to the MS 244, a relatively negative voltage is applied to the deflector 254 while a relatively positive voltage is applied to the electrode 252. As in previously described illustrative embodiments, the deflector electrodes 252 and 254 direct select ions to the MS 244 for detection while neutrals (at least a portion of which are neutralized by the DMS filter electrodes 262 and 264) are expelled through the outlet 266. The electrodes 252 and 254 may also function as DMS detector electrodes to detect some portion of the ions before delivery to the MS 244. Further, in certain embodiments, the electrodes 252 and 254 may function as deflector electrodes at certain times and as detector electrodes at other times.

In certain embodiment, the present invention includes an apparatus and method for separating ions and or detection ions, and to devices that enable analysis of volatile organic compounds such as formaldehyde and microbial volatile organic compounds such as mold and related chemical compounds using an ion mobility analyzer where an asymmetric electric field is used for ion separation, or a symmetric field that is tuned by controlling the field to provide ion separation. One example of such an ion mobility analyzer is a DMS. High electric field strength above 5000 Volts/cm can also be used to enhance ion separation. The energy imparted to the ions by using high frequency electric fields above 100 KHz, or for example up to and above 1 GHz can also be used for enhanced ion separation. Separation and detection of these ions is important in many applications including indoor air quality monitoring applications and food packaging.

The present invention also addresses a need for enhanced analysis and/or detection of air quality and pollutants from mold and/or related volatile organic compounds (VOCs) including microbial organic compounds (MVOCs) and other indoor air pollutants such as formaldehyde.

Mold and/or mold fungi include microorganisms, which occur due to infestations of food and organic materials within the living quarters. As toxic organisms, certain mold fungi produce poisonous metabolic products such as spores, mycotoxins and VOCs that may be harmful to a person's health. One existing method of the detection of mold infestation was developed using ion mobility spectrometry (IMS) that is based on the analysis of MVOCs. MVOCs are included in the chemical groups of alcohols, esters, aldehydes and ketones. MVOCs often generate a moldy odor and can be used as indicators of a mold infestation. Unfortunately, traditional time of flight IMS systems have numerous disadvantages with respect to DMS systems as they require a shutter or gate reducing their sensitivity; for good analytical performance, traditional IMS systems must be comparatively large; they suffer from losses in resolution when made of a comparably small size with respect to a DMS. Another method includes operating a GC with a mass spectrometer (MS) to detect mold. However, such systems are also suffer from other limitations, such as the need to operate at relatively low pressures which means that leaks are common and frequent maintenance is required, so that these systems are generally not robust in the field. The present invention addresses these deficiencies by providing a compact, portable, and efficient process to detect and/or analyze molds and related compounds.

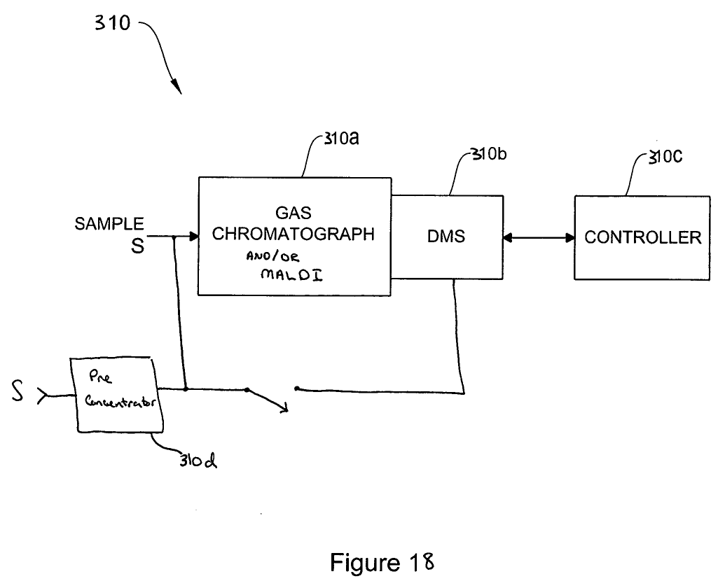

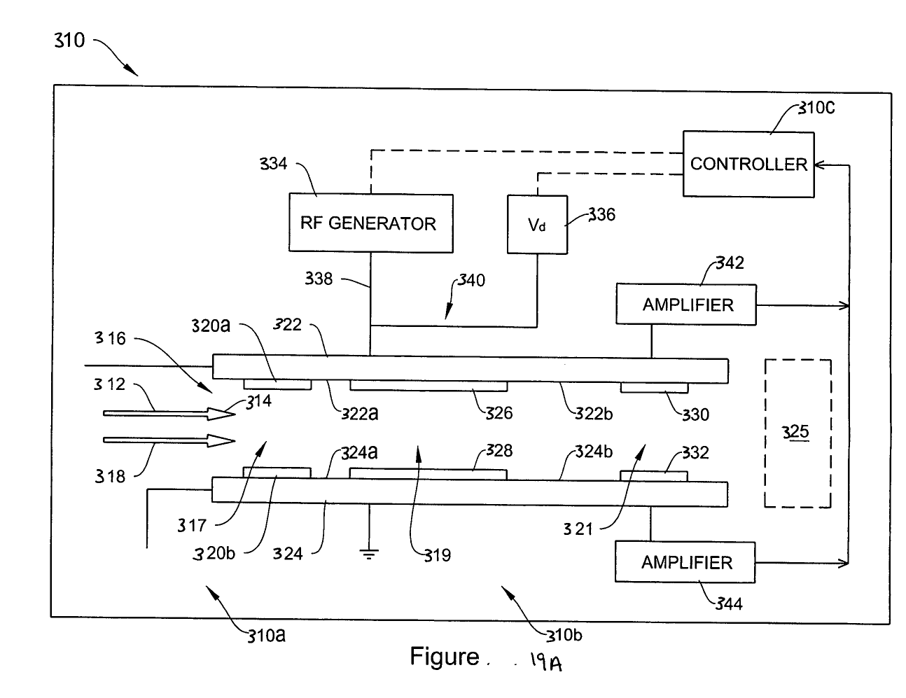

FIG. 18 shows a conceptual block diagram for a compact GC-DMS system 310 according to an illustrative embodiment of the invention. According to the illustrative embodiment, the GC 310a provides pre-separation of sample constituents prior to presenting them to the DMS 310b where the eluted constituents are temporally separated from each other, e.g., the constituents exit the GC 310a at different predictable times. A data processing system 310c controls operation of the GC 310a and the DMS 310b and processes detector signals from the DMS 310b. In an alternative embodiment, the section 310a includes a MALDI component alone or in combination with a GC.

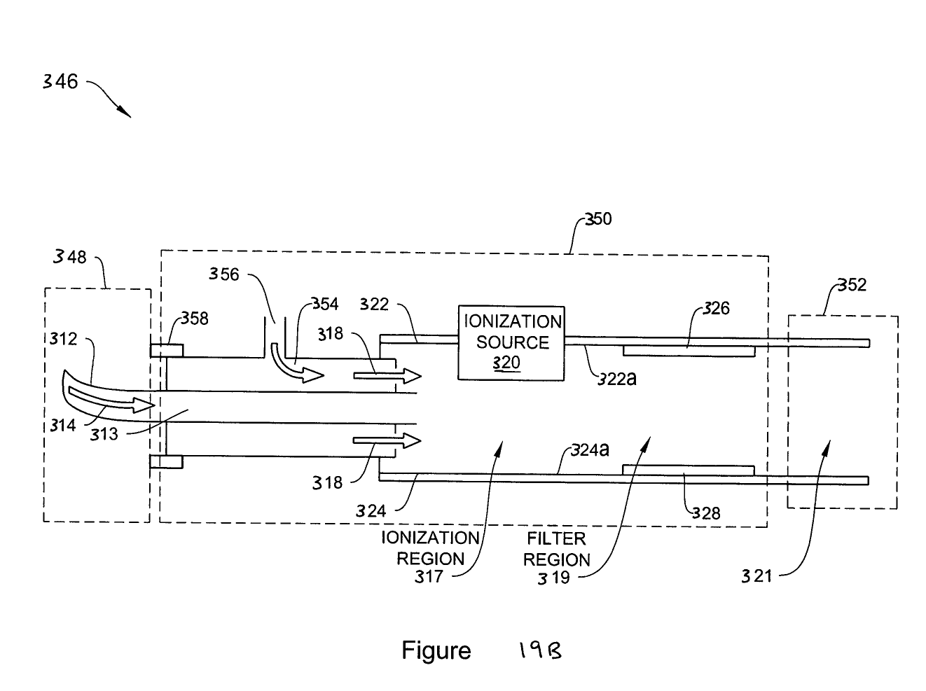

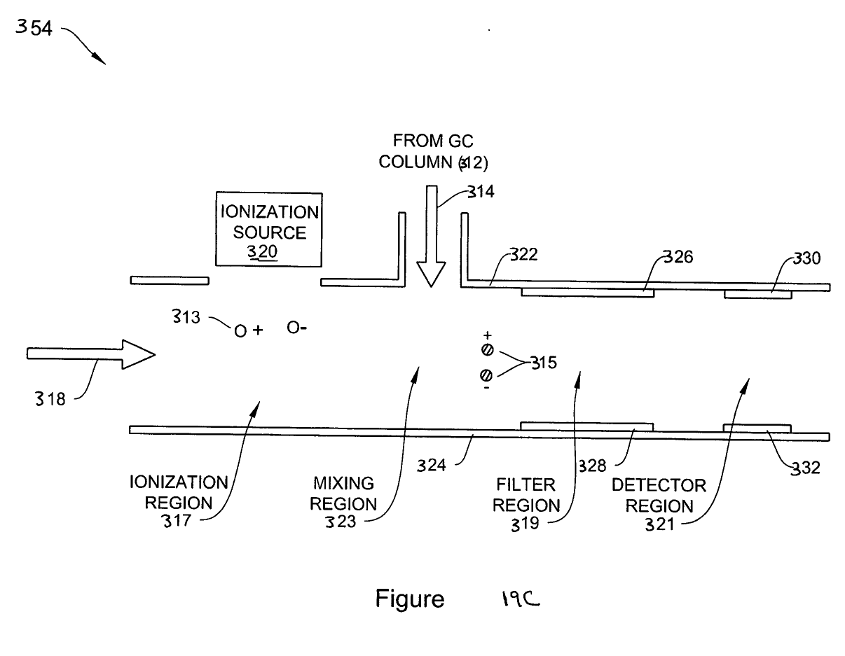

FIG. 19A shows a more detailed conceptual diagram of the compact GC-DMS system 310 of FIG. 18, however, with only a portion of the GC 310a shown. The portion of the GC 310a shown includes a capillary GC column 312. The GC column 312 delivers a sample 314 (via a carrier gas CG) from the GC 310a into the inlet 316 of a DMS flow channel formed between the substrates 322 and 324.

Coupling of the GC 310a with the DMS 310b is non-trivial. One significant hurdle that must be overcome is that a sufficient sample flow rate must be provided to the DMS 310b. More particularly, for appropriate function of the filter region 319 of the DMS 310b, the sample ions need to travel at or near a certain velocity (e.g., around 6 meters per second for an ion filter 15 millimeters long). The sample flow velocity determines the ion velocity through the filter region 319. The average velocity of the sample flow in the ion filter region 19 can be defined as V=Q/A, where Q is the sample volume flow rate and A is the cross-sectional area of the flow channel. In one example, the DMS flow channel has a cross-sectional area of about A=5×10E-6 m². Therefore, a flow rate Q=2 liters per minute of gas is required to produce roughly 6 meters per second average velocity for the sample ions through the filter region 319. If the sample ion velocity is much less than about V=6 meters per second for this device, few, if any, ions will make it through the filter region 319. Instead, they will all be deflected onto the ion filter electrodes 326 and 328 and be neutralized.

A typical flow rate of the sample 314 eluting from the GC column 312 is in the milliliters per minute range, as opposed to the about 200 milliliters (ml) to 2 liters per minute flow rate required by the DMS 310b of this illustrative embodiment. Thus, according to the illustrative embodiment, a drift gas 318 (which may be heated) is introduced into the inlet 316 with the sample 312 to augment the effluent flow from the GC column 312. The invention controls the volume and flow rate of the drift gas 318 to boost the flow rate from the GC column 312 to an optimum rate for the DMS 310b, given any particular flow channel dimensions. The flow rate of the drift gas 318 is also controlled to ensure reproducible retention times within the DMS 310b and to reduce DMS detector drift and noise. It should be noted that although the term “drift gas” is used throughout, any suitable drift effluent may be employed, for example, any suitable liquid, vapor, gas or other fluid.

According to another feature of the invention, the flow rate of the carrier gas CG in the GC column 312 may also be controlled. More specifically, by controlling the flow rate of the CG in the GC column 312 (or the ratio of CG to sample) relative to the volume flow rate of the drift gas 318, various dilution schemes can be realized which increase the dynamic range of the DMS 310b detector (see e.g., FIG. 19B). For example, if the DMS 310b is to detect high concentrations of a sample, it is desirable to dilute the amount of the sample in a known manner so that the DMS 310b can do the detection in its optimal sensitivity range.

In one illustrative embodiment, the flow channel includes an ionization region 317, a filter region 319, and a detector region 321. The ionization region 317 includes an ionization source, provided by corona discharge electrodes 320a and 320b (collectively ionization source 320) in this illustrative embodiment, for ionizing the sample 314. In other illustrative embodiments, the ionization source may be, for example, a radioactive, capacitive discharge, corona discharge, ultraviolet, laser, LED, electrospray, MALDI, or other suitable ionization source. The filter region 319 includes two parallel filter electrodes 326 and 328, mounted on the substrates 322 and 324, respectively. The filter electrodes 326 and 328 are excited by an RF waveform 338 provided by the RF generator 334 and a dc compensation voltage 340 provided by the dc source 336. The controller 310c controls both the RF generator 334 and the dc source 336 to provide particular filter field conditions selected for passing particular sample ions. The detector region 321 includes two detector electrodes 330 and 332, also mounted on the substrates 322 and 324, respectively. The detector electrodes 330 and 332 detect sample ions that pass through the filter region 319. The amplifiers 342 and 344 preprocess signals indicative of ion abundance/intensity from the detector electrodes and provide them to the controller 310c for further processing and analysis.

As described briefly above, the sample 314 and the drift gas 318 combine and enter the ionization region 317, and are ionized by the ionization source 320. The ionized sample 314 and drift gas 318 then pass into the filter region 319. As the sample ions pass through filter region 319, some are neutralized as they collide with the filter electrodes 328 and 328, while others pass to detector region 321. The controller 310c regulates the signals 338 and 340 applied to the filter electrodes 326 and 328. The filter electrodes 326 and 328 pass particular sample ions through the ion filter region 319 according to the applied control signals 338 and 340. The path taken by a particular ion is a function of its species characteristic, under influence of the RF filter field controlled by the applied electric signals 338 and 340. According to the illustrative embodiment, the controller 310c, by sweeping the dc compensation voltage (Vcomp) 341 over a predetermined voltage range, obtains a complete intensity spectrum for the sample 314. As described in more detail in the above incorporated patents and patent applications, in some illustrative embodiments, the controller 310c may also or alternatively vary the frequency, duty cycle and/or magnitude of the ac waveform 338 to select which sample ion species are passed through the filter region 319.

In a preferred embodiment, the ion filter electrodes 326 and 328 are formed on the opposed insulating surfaces 322a and 324a, respectively, of the substrates 322 and 324. According to one benefit of this configuration, forming the electrodes 326 and 328 on the insulating surfaces 322a and 324a improves detection sensitivity. More particularly, the substrate regions 322b and 324b provide electrical and spatial insulation/isolation between the filter electrodes 326 and 328 and the detector electrodes 330 and 332, effectively isolating the applied asymmetric periodic voltage (Vrf) 38 from the detector electrodes 330 and 332. The substrate regions 322b and 324b also spatially separates the filter's field from the detector electrodes 330 and 332. Such spatial and electrical isolation reduces noise at the filter electrodes 330 and 332 and increases the sensitivity of sample ion detection. Using the illustrative techniques of the invention, detector sensitivity of parts per billion and parts per trillion may be achieved.

According to another benefit, forming the filter 326 and 328 and detector 330 and 332 electrodes on an insulative substrate enables the filter electrodes 326 and 328 to be positioned closer to the detector electrodes 330 and 332, without increasing noise problems. According to another benefit, this distance reduction reduces the time it takes to make a detection, enhances ion collection efficiency and favorably reduces the system mass that needs to be regulated, heated and/or controlled. According to a further benefit, reducing the distance between electrodes also shortens the flow path and reduces power requirements. Furthermore, use of small electrodes reduces capacitance, which also reduces power consumption. Additionally, depositing the spaced electrodes on a common substrate lends itself to a mass production process, since the insulating surfaces of the substrates provide a suitable platform for forming such electrodes. One or more substrates may be combined and/or integrated into an integrated circuit and/or chip.

The sample ions that make it through the filter region 319 without being neutralized then flow to the detector region 321. In the detector region 321, either electrode 330 or 332 may detect ions depending on the ion charge and the voltage applied to the electrodes. For example, a positive bias voltage may be applied to one of the detector electrodes and a negative bias voltage may be applied to the other detector electrode. In this way, both negative and positive mode ions may be detected concurrently or substantially simultaneously; negative at one detector electrode and positive at the other detector electrode. The amplifier 342 preprocesses the signal from the detector 330 and provides it to the controller 310c, while the amplifier 344 preprocesses the signal from the detector 332 and provides it to the controller 310c. Thus, the compact GC-DMS of the invention can make multiple substantially simultaneous detections of different ion species, further speeding up the response time.

In one illustrative embodiment, the insulated substrates 322 and 324 are formed, for example, from insulating materials such as Pyrex™ glass, plastics and polymers, e.g., Teflon™, printed circuit boards, e.g., FR4, or other suitable materials. According to a further illustrative embodiment, the filter 326 and 328 and/or detector 330 and 332 electrodes are formed, for example, from gold, platinum, silver or other suitably conductive material.

Optionally, the compact GC-DMS 310 includes a pump 325 for flow generation, air recirculation and/or maintenance in the flow channel. The pump 325 may be, for example, a solid state flow generator such as that disclosed in U.S. application Ser. No. 10/943,523, filed on 17 Sep. 2004, and entitled “Solid-State Flow Generator and Related Systems, Applications, and Methods.” Longitudinal electric fields, like those described in U.S. Pat. No. 6,512,224, entitled “Longitudinal Field Driven Asymmetric Ion Mobility Filter and Detection System,” can also be used and, thereby, eliminate the need for a drift gas in the DMS entirely or partially. Both of these applications are incorporated by reference above.

FIG. 19B is a conceptual diagram of a compact GC-DMS system 346 according to an alternative illustrative embodiment of the invention. As shown, the system 346 includes a compact GC 348, a compact DMS 350, and an external detector 352. As in the case of the illustrative embodiment of FIG. 19A, the GC 348 includes a GC column 312. The GC column 312 couples to a sample flow conduit 313 via a T-connector 358, which attaches or screws into both the GC outlet and the DMS inlet housing, and allows the GC column 312 to be either passed through the DMS inlet housing or to fluidly couple to the sample flow conduit 313 to deliver the CG and sample into the ionization region 317. The T-connector 358 also serves to mechanically protect the GC column 312.

In this illustrative embodiment, the sample flow conduit 313 is surrounded by a conduit 354. A drift gas 318 flows into the conduit 354 by way of a port 356. As in the case of the system 310 of FIG. 18, the volume and flow rate of the drift gas 318 is controlled to augment the flow of the carrier gas (CG) from the GC column 312 to provide an optimum flow through the filter region 319 of the DMS 350.

As in the case of the DMS 310b, the sample 314 is ionized in the ionization region 317 by the ionization source 320. The ionized sample 314 then flows into the filter region 319. The filter electrodes 326 and 328 are formed on the surfaces 322a and 324a, respectively, of the substrates 322 and 324. Vrf and Vcomp control signals, such as the signals 338 and 340, respectively, are applied to the filter electrodes 326 and/or 328 to regulate which particular ion species pass through the filter region 319.

As in the case of the DMS 310b, the ionization region 317, the filter region 319 and the detector region 321 form the flow channel (also referred to as the drift tube) through which the sample flows during analysis. According to this illustrative embodiment, the ionization source 320 may be located remotely from the flow channel of the DMS 350, partially within the flow channel, or completely within the flow channel. Additionally, the substrates 322 or 324 may include an aperture in the ionization region 317 through which the sample 314 may interact with the ion source 320.

Also, although the flow channel is discussed as being defined by the substrates 322 and 324, it should be noted that the flow channel is, preferably enclosed. Thus, viewed from a mechanical standpoint, the drawings of FIGS. 19A and 19B should be understood as providing a cross-sectional view of the flow channel. Further, while the substrates 322 and 324 may be opposed planar substrates, they may also be opposite sides of a single cylindrical substrate. In replacement for the detector electrodes 330 and 332 of the system 310 of FIG. 19A, the system 346 includes a detector 352, which may be packaged with or separately from the GC-DMS combination 348 and 350. According to one embodiment, the detector 352 includes a mass spectrometer or other detector, which may be directly coupled to the output of the filter region 319.

FIG. 19C is a conceptual diagram of a compact GC-DMS 354 according to another illustrative embodiment of the invention. In this illustrative embodiment, rather than exposing the sample 314 to the ionization source 320, the drift gas 318, dopant or additive constituents in the drift gas are exposed to and ionized by the ionization source 320 in the ionization region 317. The sample 314 from the GC column 312 enters the flow channel in a mixing region 323. The reactant ions 313 from the ionized drift gas 318 or its constituents mix with the sample 314 in the mixing region 323 to create product ions 315. One advantage of this design is that the ionization source 320 is not exposed to the sample molecules 314 and cannot react with them, as some chemicals introduced by the GC column 312 may attack the ionization source 320 and damage it. Using this design, many additional chemicals which ordinarily cannot be used with a particular ionization source 320 can be used. The product ions 315 are then flowed through the filter region 319. The components of the filter region 319 and the detector region 321 are substantially identical and operate in the same fashion as those described above with regard to FIG. 19A. An important feature of the above described illustrative embodiments is that they enable a light weight, relatively compact, and relatively fast, e.g., millisecond to second, sample analysis by a DMS. As such, it is uniquely suited for field deployment and in-situ operations. One way that the invention achieves the above features is by reducing analyzer flow channel or path dead volume and DMS scanning rates. Dead volume is any region in a flow channel or path where there is no flow or low flow.

According to an illustrative embodiment, the invention reduces dead volume, size and weight by providing substrates, such as the substrates 322 and 324, that have multiple functional uses. For example, the substrates 322 and 324 provide platforms (or a physical support structures) for the precise definition and location of the component parts or sections of the compact GC-DMS device of the invention. The substrates, such as the substrates 322 and 324, form a housing enclosing the flow channel with the filter region 319 and perhaps the ionization region 317 and/or the detector region 321, as well as other components, enclosed. This multi-functional substrate design reduces parts count while also precisely locating the component parts so that quality and consistency in volume manufacture can be achieved. A description of an exemplary compact or micro-GC system, which may be employed with the invention, is provided by Lu et al. in Functionally Integrated MEMS Micro Gas Chromatograph Subsystem, 7^{th} International Conference on Miniaturized Chemical and Biochemical Analysis Systems, October 2003, Squaw Valley, Calif., USA.

As mentioned above, the compact GC-DMS of the invention also has unexpected performance improvements, due for example, to the shorter drift tube/flow channel, and the electrical insulation and spatial isolation provided by portions of the substrates 322 and 324. Also, because they are insulating or an insulator (e.g., glass or ceramic), the substrates 322 and 324 provide a platform for direct formation of components, such as electrodes, with improved performance characteristics.

It is should be noted that use of the substrates 322 and 324 as a support/housing does not preclude yet other “housing” parts or other structures to be built around a compact GC-DMS of the invention. For example, it may be desirable to put a humidity barrier over the device. As well, additional components, such as batteries, can be mounted to the outside of the substrate/housing, e.g., in a battery enclosure. Nevertheless, embodiments of the compact GC-DMS of invention distinguish over the prior art by virtue of performance and unique structure generally, and the substrate insulation function, support function, multi-functional housing functions, specifically, as well as other novel features.

According to various illustrative embodiments, a compact DMS analyzer, such as the DMS 310b of FIG. 18, has decreased size and power requirements while achieving parts-per-trillion sensitivity. According to one illustrative embodiment, the compact DMS 310b can have a less than about 5 Watt (W) and even less than about 0.25 mW overall power dissipation, and a size of about a 2-cm³ or less, not including a power source or display, but including an RF field generator. According to some embodiments, the compact DMS 310b of the invention has a total power dissipation of less than about 15 W, about 10 W, about 5 W, about 2.5 W, about 1 W, about 500 mW, about 100 mW, about 50 mW, about 10 mW, about 5 mW, about 2.5 mW, about 1 mW, and/or about 0.5 mW. According to further embodiments, an analyzer system employing a flow generator, such as a MEMS pump, compress fluid source or a solid-state flow generator as is described in U.S. patent application Ser. No. 10/943,523, filed on Sep. 17, 2004 (incorporated by reference above), optionally including a display (e.g., indicator lights and/or an alphanumeric display) and a power source (e.g., a rechargeable battery) compartment, along with an RF field generator, may have a total package outer dimension of less than about 0.016 m³, 0.0125 m³, 0.01 m³, 0.0056 m³, 0.005 m³, 0.002 m³, 0.00175 m³, 0.0015 m³, 0.00125 m³, 0.001 m³, 750 cm³, 625 cm³, 500 cm³, 250 cm³, 100 cm³, 50 cm³, 25 cm³, 10 cm³, 5 cm³, 2.5 cm³, with the package being made, for example, from a high impact plastic, a carbon fiber, or a metal. According to further illustrative embodiments, the DMS 310b, for example, including an RF generator, and optionally including a display, keypad, and power source compartment, may have a total package weight of less than about 5 lbs, 3 lbs, 1.75 lbs, 1 lbs, or 0.5 lbs.

In one practice of the invention, the small size and unique design of the DMS 310b enables use of short filter electrodes that minimize the travel time of the ions in the ion filter region and therefore minimize the detection time. The average ion travel time td from the ionization region to the detector is determined by the drift gas velocity V and the length of the ion filter region Lf, and is given by the relation td=Lf/V. Because Lf can be made small (e.g., 15 mm or less) in the illustrative DMS, and the RF asymmetric fields can have frequencies of about 5 MHz, the response time of the DMS can be very short (e.g., one millisecond or less), while the ion filtering (discrimination) can still be very effective.

Table 1 provides a comparison of drift tube (e.g., the constrained channel) dimensions, fundamental carrier gas velocities, and ion velocities for a various illustrative embodiments of a compact DMS analyzer 310b, depending on the flow rate (Q) available to the analysis unit. Designs 1-4 provide flow rates of varying orders of magnitude ranging from about 0.03 l/m to about 3.0 l/m. Table 1 illustrates that as the flow rate is decreased through the compact DMS b 10b, the filter plate dimensions and power requirements are reduced. Table 1 is applicable to a DMS 310b using either a sample gas or longitudinal field-induced ion motion. The time to remove an unwanted analyte is preferably less than about the time for the carrier gas CG to flow through the filter region (tratio). Also, for a particular target agent, the lateral diffusion as the ion flows through a DMS 310b is preferably less than about half the filter electrode spacing (difratio). Based on this criteria, the filter electrode dimensions may be reduced to about 3×1 mm or smaller, while the ideal flow power may be reduced to less than about 0.1 mW. Thus, even for design 4, the number of analyte ions striking the detectors is sufficient to satisfy a parts-per-trillion detection requirement.

TABLE 1
Illustrative DMS Analyzer System Design Specifications and Characteristics

| | | | Design 1 | Design 2 | Design 3 | |
|---|---|---|---|---|---|---|
| | | | Q = 3 l/m | Q = 0.3 l/m | Q = 0.3 l/m | Design 4 |
| Description | Units | Symbol | Baseline | Base dimen | scaled | Q = 0.03 l/m |
| plate dimensions | | | | | | |
| *length | m | L | 0.025 | 0.025 | 0.005 | 0.001 |
| *width | m | b | 0.002 | 0.002 | 0.001 | 0.0004 |
| *air gap | m | h | 0.0005 | 0.0005 | 0.0005 | 0.0002 |
| *volume flow rate | l/min | Qf | 3 | 0.3 | 0.3 | 0.03 |
| Flow velocity | m/s | Vf | 50 | 5 | 10 | 6.25 |
| pressure drop | Pa | dPf | 1080 | 108 | 43.2 | 33.75 |
| flow power | W | Powf | 0.054 | 0.00054 | 2.16E−04 | 1.69E.05 |
| RF excitation | V | Vrf | 650 | 650 | 650 | 260 |
| design ratios | | | | | | |
| Time to remove | s | tratio | 0.0128 | 0.0013 | 0.0128 | 0.0160 |
| unwanted analyte | | | | | | |
| divided by carrier time | | | | | | |
| wanted ions-lateral | s | difratio | 0.200 | 0.632 | 0.200 | 0.283 |
| diffusion divided | | | | | | |
| by half gap | | | | | | |
| ions to count per cycle | — | Nout | 1.22E+07 | 1.22E+06 | 1.22E+06 | 1.22E+05 |

The short length of the DMS spectrometer section 310b and small ionization volume mean that the GC-DMS of the invention provides the ability to study the kinetics of ion formation. If the ions are transported very rapidly through the DMS section, the monomer ions are more likely to be detected since there is less time for clustering and other ion-molecule interactions to occur. By reducing the ion residence time in the DMS section, the ions have less opportunity to interact with other neutral sample molecules to form dimmers (an ion with a neutral attached) or unwanted clusters. The small size of the GC-DMS of the invention, according to one feature, enables ion residence times of about 1 ms. Thus, a total spectra (e.g., sweeping Vcomp over a range of about 100 volts) can be obtained in under one second.

Ion clustering can also be affected by varying the electric field strength. By applying fields with larger amplitudes or at higher frequencies, the amount of clustering of the ions can be reduced, representing yet another mechanism of enhanced compound discrimination.

According to one illustrative embodiment of the invention, a GC-DMS system 310 was formed as follows: A model 5710 gas chromatograph (Hewlett-Packard Co., Avondale Pa.) was equipped with a HP splitless injector, 30 m SP 2300 capillary column (Supelco, Bellefonte, Pa.), (columns as short as 1 m have also been used) and a DMS detector. Air was provided to the GC drift tube at 1 to 2 liters/minute (L/m) and was provided from a model 737 Addco Pure Air generator (Addco, Inc., Miami, Fla.) and further purified over a 5 Å molecular sieve bed (5 cm diameter×2 m long). The drift tube was placed on one side of an aluminum box, which also included the DMS electronics package. A 10 cm section of capillary column was passed through a heated tube to the DMS. The carrier gas was nitrogen (99.99%) scrubbed over a molecular sieve bed. Pressure on the splitless injector was 10 psig and the split ratio was 200:1.

The Vcomp was scanned from about +/−100 Vdc. The asymmetric waveform had a high voltage of about 1.0 kV (20 kV cm⁻¹) and a low voltage of about −500 V (−5 kV cm⁻¹). The frequency was about 1 MHz and the high frequency had about a 20% duty cycle, although the system has been operated with frequencies up to about 5 MHz. The amplifier was based upon a Analog Devices model 459 amplifier and exhibited linear response time and bandwidth of about 7 ms and about 140 Hz, respectively. The signals from the detectors were processed using a National Instruments board (model 6024E) to digitize and store the scans and specialized software to display the results as spectra, topographic plots and graphs of ion intensity versus time. The ion source was a small 63Ni foil with total activity of about 2 mCi. However, a substantial amount of ion flux from the foil was lost by the geometry of the ionization region and the estimated effective activity was about 0.6 to 1 mCi.

As discussed above, the invention, in various embodiments, addresses deficiencies in the prior art by employing systems, methods, and devices using a time varying electric field to separate an ionized sample. One implementation employs a DMS system to rapidly and efficiently perform in-situ (on-site) analysis of molds and associated VOCs. The DMS system may be employed to locate mold and/or associated VOCs in walls of a building, packages, freezers, refrigerator, grain storage facilities, food processing plants, food storage facilities, compartments of vehicles or residents, work spaces, schools, hospitals, public transportation areas, arenas, and any location where humans may be exposed to harmful mold and/or mold by products. The DMS system may be integrated with other systems to control and maintain indoor air quality (IAQ) for certain occupational structures.

In one embodiment, a DMS is employed to detect one or more mold organisms and/or VOCs. In certain embodiments, the GC-DMS system 310 operates in combination with a GC 310a as shown in FIGS. 18 and 19A-C. The GC-DMS system 310 may optionally include a pre-concentrator 310d that receives a sample input and delivers the concentrated sample to the GC 310a. Alternatively, the pre-concentrator 310d may bypass the GC 310a and provide a concentrated sample to the DMS 310b. The pre-concentrator 310d may include a trap and/or injector. FIGS. 1 and 2A-2C of U.S. patent application Ser. No. 11/050,288, filed on Feb. 2, 2005, show a GC-DMS system 10 according to an illustrative embodiment of the invention, the entire contents of which are incorporated herein by reference.

The GC-DMS system 310 and/or DMS 310b may provide for detection at concentrations less than about 90 parts-per-billion (PPB), less than about 50 PPB, less than about 20 PPB, less than about 10 PPB, less than about 5 PPB, less than about 1 PPB, less than about 500 parts per trillion (PPT), less than about 200 PPT, less than about 100 PPT, less than about 50 PPT, less than about 20 PPT, less than about 10 PPT, and less than about 5 PPT. The GC-DMS system 30 may include multiple ion sources, each tailored to the analysis of certain molds and/or VOCs.

The DMS 310b and/or GC-DMS system 310 may be employed with other detection systems and/or operate independently to analyze certain IAQ compounds including, without limitation, carbon monoxide, VOCs, mold, radon, pesticides, comfort gases (0₂, CO₂, H₂0), nitrogen dioxide, tobacco smoke, asbestos, and formaldehyde. The DMS 310b may be configured to analyze certain VOCs including, without limitation, acetaldehyde, acetone, methyl ethyl ketone (2-butanone), styrene, toluene, benzene, xylene, methanol, and ethonal. The DMS 310b may be configured to analyze certain molds including, without limitation, stachybotrys (black mold), cladosporium, penicillium, and aspergillius. The DMS 310b may be configured to analyze certain MVOCs including, without limitation, geosmin, MIB, 2-methyl isoboreol, 2-methoy furan, 1-octen-3-ol, dimethylsulfide, 2-heptanone, 2-pentanal, chlorogensene-d₅, 3-octanone, and 2-methoyl-1-butanol. These MVOCs may be the byproduct of certain mold resulting from mold colony growth.

In one embodiment, MVOCs and/or VOCs are detected by operating a DMS in a non-RF mode and then operating the DMS with the RF on to detect a particular mold. In another embodiment, UV ionization and/or soft (low powered) ionization is employed. In further embodiments, high powered ionization is employed to enable fragmentation of certain samples such as mold spores and/or VOCs to provide additional information to identify one or more mold species. The DMS may be configured to detect and or analyze monomers, dimmers, trimers, clusters (de-clusters) associated with samples including molds and VOCs.

In another embodiment, separations are achieved based on ion species, including light versus heavy and polarity, according to the displacement vector from the DMS′ filter field. Also, the DMS 310b may be configured to provide concurrent detection of both positive and negative ions species.

In certain embodiments, the use of a DMS 310b advantageously provides enhanced sensitivity to detect MVOC having concentrations on the order of 0.1 ppb. Additionally, selectivity is enhanced by configuring the DMS 310b to detect certain key markers (i.e., the presence of particular MVOCs at particular DMS 310b conditions). However, a DMS spectrum may also be employed to concurrently detect the presence of multiple markers, i.e., provide a full spectrum scan of the present MVOCs, to identify one or more mold species.

In one embodiment, a compact DMS analyzer device (e.g., microDMx system manufactured by the Sionex Corporation of Bedford, Mass., USA) is employed for mold detection. As fungi, mold in particular, grow their metabolisms release Microbial Volatile Organic Compounds (MVOCs) in particular Geosmin and 2-methyl isoboreol which are two examples. Evidence has already been established using pre-concentration-GC-MS techniques that these MVOCs are present in the air at concentrations around 0.1 ppbv to 10 ppbv when mold is present. EPA Methods TO-14 and TO-15 are frequently used to detect these MVOCs using laboratory instruments following sample collection into passivated Suma canisters at the location where the mold growth is suspected. The current mold detection market is based on a service business model where samples are taken at the suspected location. For example, either i) spores are collected on culture dishes or ii) air is sampled into canisters and then sent to a laboratory for analysis. No real-time in-situ detection method for mold is available today which could be realistically deployed in buildings or multiple locations.

Due to the sensitivity and selectivity of a DMS, a DMS system such as system 310, employing a pre-concentrator and/or GC, may be utilized for remote real-time in-situ monitoring of specific MVOCs at the required levels of approximately 0.1 ppbv. Since these systems are small and relatively low cost with nominal power requirements they may be deployed in a building infrastructure in a wireless or wireline communications networked environment to continuously monitor for the presence of mold. In addition the system may be also used in a handheld scenario for the real-time location and identification of mold issues for inspection or troubleshooting.

Since the DMS analyzer technology such as DMS analyzer 310 is not hardware governed for the detection of specific compounds, the DMS analyzer may also be utilized to detect other Indoor Air Quality (IAQ) compounds such as VOCs simply by changing firmware and/or software of the system. In certain embodiments, the DMS analyzer system 310 may used to identify difficult to detect compounds such as formaldehyde which is of specific concern for IAQ.

In certain embodiments, a DMS 310 is configured for detecting mold and/or MVOCs in an efficient, ultra compact, and less power-consuming ion mobility based system and/or sensor.

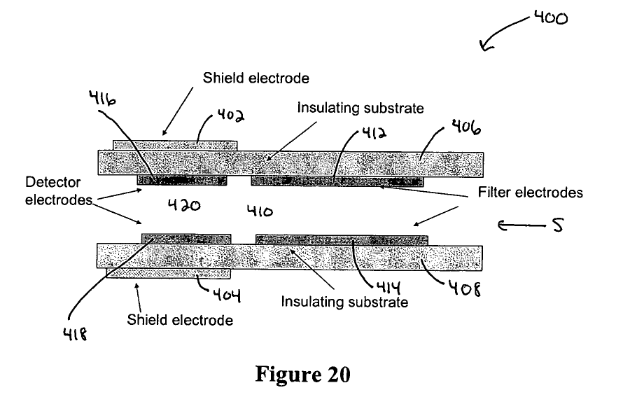

FIG. 20 is a conceptual diagram of an ion mobility based analyzer 400 including detector shielding plates 402 and 404 according to an illustrative embodiment of the invention. In one embodiment, the analyzer 400 is a DMS. The analyzer includes a flow path 410 defined by insulating substrates 406 and 408 that enables the transport, filtering, and detection of a sample S. The analyzer 400 includes filter electrodes 412 and 414 along with detector electrodes 416 and 418. The analyzer 400 may include an ion source for ionizing a portion of the sample S. The filter electrodes 412 and 414 may produce a time-varying electric field and compensation field to effect filtering of the sample ions passing therebetween.

In one embodiment, signals as low as 0.1 picoamps are routinely processed, making the sensor and/or analyzer 400 extremely sensitive to external fields. Sample detection devices such as analyzer 400, which may be used in portable or mobile applications, can be particularly sensitive to changing electrostatic fields that can exist in devices using charged insulating surfaces (e.g., plastics, ceramics, glasses). Also, moving air, water and even people may create large disruptive electrostatic fields. In certain embodiments, the detector electrodes 416 and/or 418 of the analyzer 400 can be effectively shielded by the application of a conductive material 402 and/or 404 to the outside surfaces of one or both of the insulating substrates 406 and 408. In one embodiment, the conductive layers, plates, and/or electrodes 402 and 404 are connected to a fixed electrical potential to complete the shield. For example, the electrical potential may be ground, 0 volts, or some other positive or negative potential.

Without the shield 402 or 404, any stray field may have direct access to the detector plates 416 and/or 418. Even if the analyzer 400 includes a housing where the detector electrodes 416 and 418 are surrounded by a faraday shield, the analyzer 400 itself can create charges. Any change in the distance between a charged surface and the detector electrodes 416 and 418 may produce a stray unwanted electrical signal on one or both of the detector electrodes 416 and 418. This stray electrical signal may limit the sensitivity of the detector 420 and even cause false erroneous responses or alarms from the detector 420 and/or analyzer 400.

In one embodiment, the shielding 402 and/or 404 around the detector electrodes 416 and 418 is located on surfaces that do not move, or that move in such a way as to maintain a fixed distance with the detector electrodes 416 and 418. The use of a shield electrode 402 and/or 404 in conjunction with a DMS, also known as FAIMS, advantageously provides higher noise rejection due to vibration and other stray sources of noise. The shield electrodes 402 and/or 404 can be kept away from the end of the filter electrodes 412 and/or 414 (so that there is no overlap) in order to minimize analyzer 400 or filter capacitance levels.

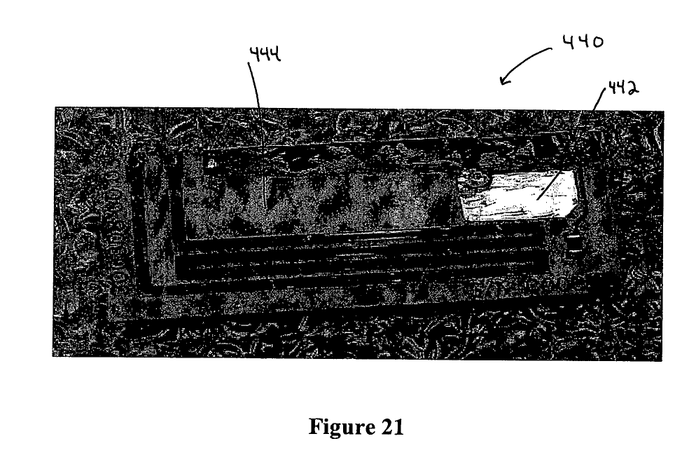

FIG. 21 is a perspective view of an ion mobility based analyzer housing portion 440 including an insulating substrate 440 associated having a shielding plate 442 according to an illustrative embodiment of the invention. Although not shown, in one embodiment, the housing portion 440 includes at least one detector electrode integrated with a bottom surface of the insulating substrate 444 while also adjacent to or in proximity to the shielding plate 442. In one embodiment, the insulating substrate 444 is substantially sandwiched between the shielding plate 442 and at least one detector electrode.

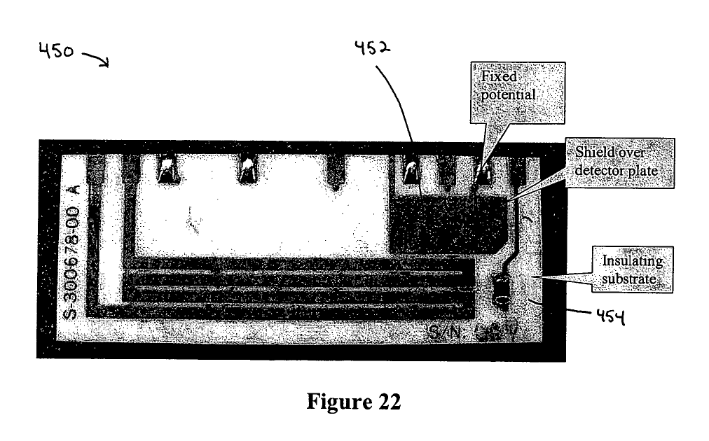

FIG. 22 is a perspective view of another ion mobility based analyzer housing portion 450 including insulating substrate 454 having a shielding section 452 for shielding a detector according to an illustrative embodiment of the invention. In one embodiment, a fixed electrical potential or voltage is applied to the shielding section 452 to counter the effects of any stray electrostatic field that may introduce noise to a detector in proximity to the shielding section 452. In certain embodiments, the shielding section includes a metal such as, without limitation, silver, gold, copper, aluminum, and any like metal, or alloy of metals.

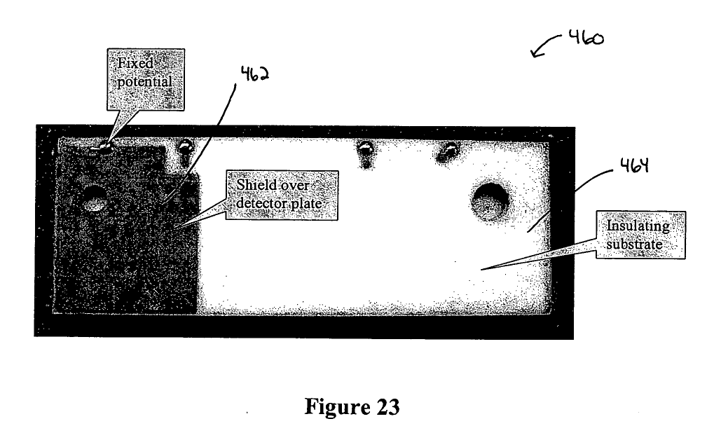

FIG. 23 is a another perspective view of an ion mobility based analyzer housing portion 460 including an insulating substrate 464 having a shielding section 462 for shielding a detector according to an illustrative embodiment of the invention.

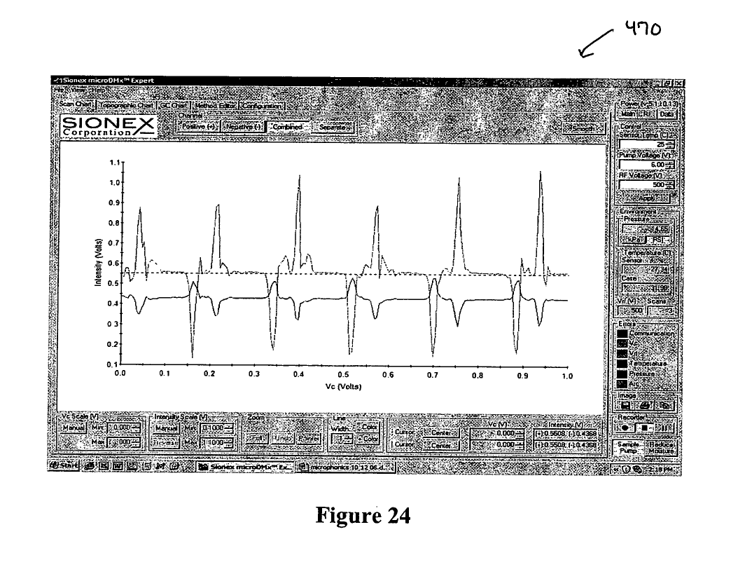

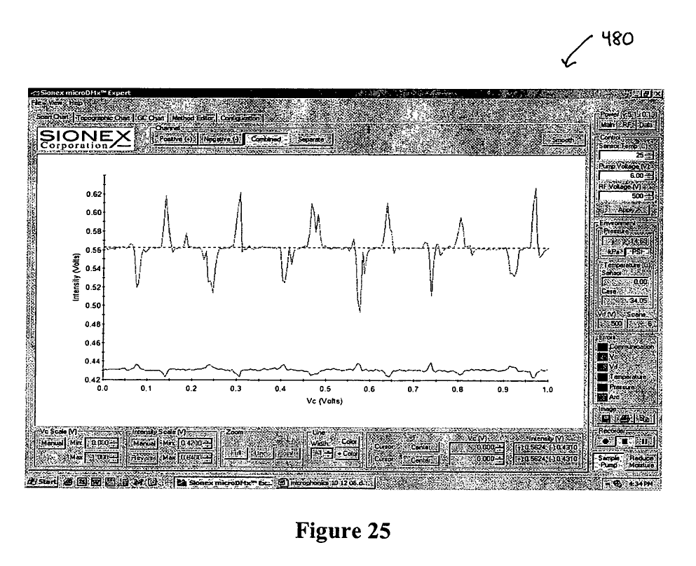

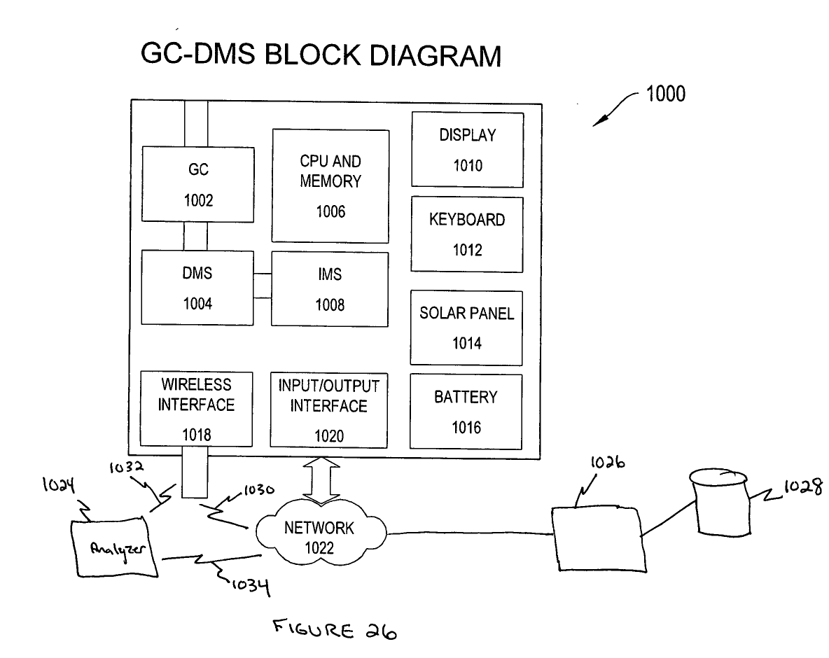

FIG. 24 is a graph 470 of ion intensity vs. compensation voltage (i.e., noise amplitude) of an unshielded ion mobility based detector during a horizontal shake test. FIG. 25 is a graph 480 of ion intensity vs. compensation voltage (i.e., noise amplitude) of a shielded ion mobility based detector during a horizontal shake test. By comparing FIGS. 24 and 25, it is shown that the noise amplitude from the horizontal shake test was reduced from 850 mv. p-p to 120 mv. p-p for the positive channel (7× reduction) and 250 mv. p-p to <20 mv. p-p for the negative channel (21× reduction). In a similar tip-over test, the noise amplitude was reduced from 840 mv. peak to 90 mv. peak for the positive channel (9× reduction); 870 mv. peak to 250 mv. peak for the negative channel (3.5× reduction).

FIG. 26 is a block diagram of a GC-DMS sensor system 1000 including a wireless interface 1018, according to an illustrative embodiment of the invention. The GC sensor system 1000 includes various sensor components such as GC 1002, DMS 1004, IMS 1008, CPU/Memory 1006, Display 1010, Keyboard 1012, solar panel 1014, battery 1016, wireless interface 1018, input/output interface 1020. The system 1000 may be connected via interface 1020 to a network 1022 such as the Internet or a local Ethernet to facilitate communications with other sensors or a centralized processing system 1026 that controls and/or coordinates the operation of multiple sensor systems 1000. In one embodiment, the system 1000 includes at least one of a micromachined mass spectrometer, chemical sensor, or like sample identification component.

In one embodiment, the interface 1018 communicates with the system 1026 via wireless channel 1030. The wireless interface 1018 may also enable communications among multiple sensor systems 1000 via a wireless communications network. For example, the wireless interface 1018 may employ the wireless channel 1032 to exchange information with another analyzer 1024. The analyzer 1024 may relay information to and from the network 1022 via wireless channel 1034 to enable the system 1000 to exchange information with the central system 1026. Depending on the power capabilities of the system 1000, it may be advantageous to exchange information with another analyzer 1024 in relatively close proximity, and then allow the analyzer 1024 to relay to information to the central system 1026, possibly via another intermediary analyzer. In one embodiment, a plurality of analyzers can form a communications chain to enable the exchange of information between the system 1000 and the central system 1026. At least one of the wireless channels 1030, 1032, and 1034 may be based on one or more proprietary or standard wireless protocols such as, without limitation, cellular standards (e.g., GSM, 3GSM, EDGE, cdma2000, EVDO, TDMA, AMPS), WiFi (802.x), WiMax, bluetooth, satellite, personal area networks, wireless local area networks, or any like wireless protocol or technology.

In certain embodiments, the system 1000 includes a data store of known ion species, including volatile organic compounds. In one embodiment, the data store is contained within the processor and memory 1006 of the system 1000 or in another memory storage component within the system 1000. The processor 1006 compares the acquired detection data from at least one detector of the DMS 1004 with a plurality of detection data sets associated with known ion species, including volatile organic compounds. A match between the acquired detection data and at least a portion of one of the detection data sets enables the processor 1006 to identify one or more ion species from the acquired detection data. In another embodiment, the data store is included in a remote database such as database 1028. Thus, the system 1000 may send detection data, acquired by a detector of DMS 1004, to the central server 1026, which may then compare the detection data with a plurality of detection data sets, each set being associated with a known ion species and/or volatile organic compound, in the data store of the database 1028. In yet another embodiment, the analyzer 1024 may include a data store of known detection data sets.

The analyzer 1024 may update the system 1000 with known detection data information periodically or intermittently during adhoc contact with the system 1000. In one embodiment, the analyzer 1024 may receive the acquired detection data from the system 1000 and use its own processor and data store to identify the ion species based on the acquired detection data. The analyzer 1024 may then relay the identification information to the system 1000, the central processor 1026, or to other analyzers. The central system 1026 may also update the system 1000 with known detection data information periodically or intermittently during contact with the system 1000. In certain embodiments, the central system 1026 may control and/or monitor a networked set of analyzers, including system 1000 and analyzer 1024. The central system may maintain a geographic mapping of the location of various analyzers 1024 which may enable to central processor to track the spread or progression one or more ion species throughout a geographic area such as a battlefield, city, border area, or the like or a structure such as a building, theatre, stadium, ship, or like structure.

In one embodiment, the detection data includes at least one of a ionogram, a two-dimensional spectrum (ion intensity vs. compensation voltage), three-dimensional dispersion plot (Vrf vs. compensation voltage vs. ion intensity), mass spectrum (ion intensity vs. mass or m/z), select features of a spectrum, select windows of a spectrum, and select peaks of a spectrum, select shapes of a spectrum including slope, curvature, valley and peaks and like features, and time-of-flight vs. intensity information. Further details regarding a data store and the type of information that may be included in the detection data are provided in U.S. Pat. No. 7,157,700, issued on Jan. 2, 2007, the entire contents of which are incorporated herein by reference.

In certain embodiments, the sensor is embedded in a flashlight, lapel, helmet, uniform, shoes, boots, jacket, glasses, or any other wearable element. In another embodiment, the sensor includes a global positioning system (GPS) interface. In a further embodiment, the sensor is wearable and/or communicates with a local or remote display (e.g., a heads-up display on a firefighter's helmet).

In certain embodiments, a solar cell, a fuel cell, and/or a transducer circuit provide a sufficient power source. In one embodiment, the system 1000 includes a solar panel and interfaces with a rechargeable battery 1016 to provide a solar power source. This allows for monitoring in locations where hardwired power sources are not convenient, or battery replacement is problematic. The source of light energy could be the sun, or artificial lighting, and therefore the sensor 1000 could be used inside or outdoors. The sensor 1000 could be portable or mounted in a fixed location. The solar powered panels could be attached to the sensor 1000, or mounted separately to optimize light collection. The solar panels could also be wearable. In one embodiment, the device of FIG. 40 includes an Ethernet communications interface that enables the extraction of sufficient power for DMS analysis and/or processor processing.

The sensor 1000 or other GC-DMS system such as GC-DMS system 310, or any other type of DMS system, may include direct driving control circuitry such as, for example, a MOSFET switch which comprises a control device having low voltage and high frequency capabilities to support significantly narrower gaps within an ultra compact DMS. In one embodiment, the GC-DMS system 310 employs a ring resonator capable of supporting frequencies in the microwave range or higher. In another embodiment, the direct drive is capable of directly generating a square wave signal for the asymmetric field of at least one filter electrode.

In certain embodiments, a GC-DMS system includes a DMS where the DMS field is used as a driving field that preferentially transports ions. In one embodiment, a sample is ionized and introduced into the analytical region (filter region) or is introduced into an ionization region and then flows to the analytical region, such as by electric field. The ions can move in the analytical region against or with a gas flow, such as where a clean gas flow (e.g., filtered air) and flows counter to average or net ion motion. The ions move toward then away from the downstream detector electrode as they travel toward the detector electrode, resulting in an average or net travel, e.g., in two steps forward and one step back. Additional and other means, such as a DC field gradient can be added for assisting ion transport.

The system may use the field dependence of ions, whether high or low. Separations can be achieved based on ion species, including light versus heavy and polarity, according to the displacement vector form the field. Simultaneous detection of both positive and negative ions species is possible as in Miller, et al., U.S. Pat. Nos. 6,495,823 and 6,512,224, both of which are incorporated herein by reference in their entirety.

Thus, in certain embodiments a longitudinal DMS (LDMS) and IMS may be included in the same device and/or integrated package. The LDMS may further interface with one or more GC columns, that may also be integrated into the same package. In an illustrative embodiment, the DMS device provides DMS detection capability but also the DMS is a detector for a conventional IMS, such as time of flight or Fourier IMS. In one mode of operation, the DMS actually measures differential time of flight. In another embodiment, a gating mechanism provides a pulse introduction of sample and enables measurement of time-of-flight.

According to one embodiment, a compact integrated ion mobility based analysis system includes at least one gas chromatograph (GC) column and at least one ion mobility based sample analyzer. Optionally, the at least one GC and the at least one ion mobility based sample analyzer are formed as an integrated circuit in a single package. The GC column receives a sample and elutes constituents of the sample, each of the eluted constituents being temporally separated from each other. The mobility based sample analyzer receives the eluted constituents from the GC and analyzes them based on their ion mobility characteristics of the eluted constituents. According to one feature of the invention, both the carrier gas in the at least one GC column and the drift gas in the at least one ion mobility based sample analyzer consist substantially of air.

According to one feature, the at least one GC column is formed as a capillary column in a substrate. The at least one GC column may be configured, for example, to include a spiral portion, and/or a spiral/counter-spiral portion on the substrate. It may also be configured to have one or more straight portions and one or more curved portions. The spirals may trace a plurality of any suitable geometric patterns including, for example, an oval, triangle or rectangle. According to various configurations, the at least one GC column has a length of less than about 20 meters, 10 meters, 8 meters, 6 meters, 4 meters, 2 meters, or 1 meter, or 100 cm, or 10 cm, or 1 cm. The substrate on which the GC column is formed may be made, for example, from silicon, GaAs, saphire, alumina, plastic polymer, or other substrate material.

Generally the ionization sources which can be used in or with typical ion mobility based analyzer systems may include field emission tip based ionization source which emits electrons at relatively low voltages, the field emission tip may be formed by nano-fabrication such as from carbon nano-tubes. The ionization source may be a reverse flow plasma source, where the ions formed by the plasma are extracted from the plasma region by an electric field which drives the ions into the DMS or IMS counter to a gas or air flow. In this way, neutrals such as NOx's are minimized and a favorable negative ion chemistry preserved in the DMS.

The ionization source may also be radioactive Ni63 or other radioactive materials. The ionization source may be a PID, or UV ionization source or an LED or a UV LED or the like. Another ionization source may be realized by electrospraying a solvent which ionizes the solvent and then mixing the ionized solvent with the analyte. A charge exchange occurs which then ionizes the analytes.

The detector or detectors employed in the foregoing ion mobility based analyzer systems may include a functionalized chemo-resistive transducer, a polymer functionalized field effect transistor (FET). The FET gate may be functionalized to collect select ions and/or ion species. A particular FET structure may be employed such as a MOSFET, JFET, and other like FET or like semiconductor structure such as a transistor, diode, switch, varactor, and so on. The detector may include a dielectric barrier discharge detector. The detector may include a functionalized nanotube detector and/or a cantilever type detector. The cantilever type detector may be silicon micromachined. The detector may include one or more nano-sensor and nano-structures to facilitate the detection or binding of certain ions or molecules. The nanotube may be utilized as a semi-conducting transducer. The detector may also detect based on surface plasmon resonance characteristics and interactions between the analyte and the transducer. In other applications the DMS can be coupled to a RAMAN spectrometer or other optical spectrometers for enhanced compound identification or detection. The Differential Mobility Spectrometer can be used as a pre-filter selectively filtering ions which are then further detected or analyzed by the RAMAN spectrometer.

Detection in the cantilever detector may be based on resonance change of the cantilever or positional deflection of the cantilever. This detection provides different, orthogonal data to the information based on ion mobility or differential mobility provided by DMS and IMS systems.

Additionally, components of the above systems may be nano-machined and/or machined using nano technology or have a feature size that is on the order of a nano-meter. For example, the systems may include nanoinjectors and/or traps nano-based columns, and columns including or being packed with nanotubes.

It will be appreciated that in various of the above embodiments, a spectrometer can be provided in any arbitrarily shaped geometry (planar, coaxial, concentric, cylindrical) wherein one or more sets of electrodes are used to create a filtering electric field for ion discrimination. The same or a second set of electrodes, which may include an insulative or resistive layer, may also be used to create an electric field at some angle to the filtering electric field for the purpose of propelling ions through the filtering field to augment or replace the need for pump-driven propulsion such as with a carrier gas.

The examples disclosed herein are shown by way of illustration and not by way of limitation. Although specific features of the invention are shown in some drawings and not in others, this is for convenience only as various features may be combined with any or all of the other features in accordance with the invention.

What is claimed is:

1. A sample analyzer comprising:
a MALDI ionization source,
an ion mobility based filter for receiving ions from the MALDI ionization source and for providing a time-varying electric field through which select ions are passed, and
a mass spectrometer for measuring the ion intensity of the ions received from the ion mobility based filter.

2. The analyzer of claim 1, wherein the MALDI ionization source operates at atmospheric pressure.

3. The analyzer of claim 2, wherein the MALDI ionization source employs pulsed dynamic focusing.

4. The analyzer of claim 2, wherein the MALDI ionization source includes a desorption surface and a capillary.

5. The analyzer of claim 4, wherein the capillary is positioned between about 1 to 4 mm from the desorption surface.

6. The analyzer of claim 4, wherein the capillary includes a substantially bi-conical outer surface.

7. The analyzer of claim 6, wherein the capillary directs the flow of hot clean gas radially away from the sample ion source on the desorption surface.

8. The analyzer of claim 1, comprising a deflector electrode for directing ions from the ion mobility based filter toward on inlet of the mass spectrometer.

9. The analyzer of claim 1, wherein the ion mobility based analyzer includes a flow path for the ions that is substantially orthogonal to the ion flow in the mass spectrometer.

10. A compact portable ion mobility based analyzer comprising:
a sample introduction section for collecting an airborne sample, the sample possibly including at least one volatile organic compound,
an ion source for ionizing a portion of the sample,
an ion mobility based filter for filtering the at least one volatile organic compound,
a detector for acquiring detection data associated with the at least one volatile organic compound, and
a processor for identifying the at least one volatile organic compound by comparing the acquired detection data with a data store associated with volatile organic compounds.

11. The analyzer of claim 10, wherein the ion mobility based analyzer includes at least one of a DMS and an IMS.

12. The analyzer of claim 10, wherein the data store resides within the analyzer.

13. The analyzer of claim 1 comprising a transceiver for exchanging at least one of control and detection data information with a central processing system.

14. The analyzer of claim 13, wherein the processor sends identification information to the central processing system.

15. The analyzer of claim 13, wherein the central processor updates the data store with updated detection data set information.

16. The analyzer of claim 13, wherein the transceiver is a wireless transceiver.

17. The analyzer of claim 13 comprising a second analyzer, the second analyzer configured to exchange at least one of control and detection data information with the processor.

18. The analyzer of claim 17, wherein the second analyzer is configured to exchange at least one of control and detection data information with at least one of a third analyzer and the central processing system.

19. The analyzer of claim 10, wherein the data store resides within a remote system.

20. The analyzer of claim 10, wherein the volatile organic compound includes at least one of acetaldehyde, acetone, methyl ethyl ketone (2-butanone), styrene, toluene, benzene, xylene, methanol, and ethonal.

21. The analyzer of claim 10, wherein the volatile organic compound includes at least one of an Indoor Air Quality (IAQs) compounds and microbial organic compounds (MVOCs).

22. The analyzer of claim 21, wherein the MVOCs include at least one of geosmin, MIB, 2-methyl isoboreol, 2-methoy furan, 1-octen-3-ol, dimethylsulfide, 2-heptanone, 2-pentanal, chlorogensene-d₅, 3-octanone, and 2-methoyl-1-butanol.

23. The analyzer of claim 21, wherein the IAQs include at least one of carbon monoxide, VOCs, mold, radon, pesticides, comfort gases (0₂, CO₂, H₂0), nitrogen dioxide, tobacco smoke, asbestos, and formaldehyde.

24. The analyzer of claim 10, wherein the processor is configured to identify at least one mold species by comparing the acquired detection data with a data store including a plurality of detection data sets, each detection data set associated with a mold species.

25. The analyzer of claim 24, wherein the mold species include at least one of stachybotrys (black mold), cladosporium, penicillium, and aspergillius.

26. The analyzer of claim 10, wherein the sample introduction section includes a gas chromatograph (GC) column.

27. An ion mobility based analyzer comprising:
an ion mobility based filter for passing select ions,
a detector for detecting ions from the ion mobility based filter,
an insulating substrate in communication with the detector, and
a shield in communication with the insulating substrate for reducing the amount of electrostatic interference to the detector.

28. The analyzer of claim 27 wherein the insulating substrate includes at least one of glass, silicon, a polymer, and a semi-conductive material.

29. The analyzer of claim 27, wherein the detector includes at least one electrode that is micromachined to the insulating substrate.

30. The analyzer of claim 27, wherein the insulating substrate is positioned substantial between the detector and the shield.

31. The analyzer of claim 27, wherein the shield embedded on a top surface of the insulating surface while at least one electrode of the detector is embedded on a substantially opposing bottom surface of the insulating surface.

32. The analyzer of claim 27, wherein the shield includes a conductive material.

33. The analyzer of claim 32, wherein the conductive material is maintained at a select electrical potential.

34. The analyzer of claim 27, wherein the shield is positioned on the insulating substrate proximate to the detector to inhibit electrostatic interference to the detector.

35. The analyzer of claim 34, wherein the shield is positioned on the insulating substrate a sufficient distance from the filter to reduce formation of filter fringe fields.
